(19) United States
(12) Patent Application Publication
(10) Pub. No.: US 2014/0272408 A1
(43) Pub. Date: Sep. 18, 2014

(54) WATER-DISPERSIBLE ACRYLIC PRESSURE-SENSITIVE ADHESIVE COMPOSITION, PRESSURE-SENSITIVE ADHESIVE LAYER, AND PRESSURE-SENSITIVE ADHESIVE SHEET

(71) Applicant: NITTO DENKO CORPORATION, Ibaraki-shi, Osaka (JP)

(72) Inventors: Tatsumi Amano, Ibaraki-shi (JP); Yu Morimoto, Ibaraki-shi (JP); Kazuma Mitsui, Ibaraki-shi (JP); Kousuke Yonezaki, Ibaraki-shi (JP); Kyoko Takashima, Ibaraki-shi (JP)

(73) Assignee: NITTO DENKO CORPORATION, Ibaraki-shi, Osaka (JP)

(21) Appl. No.: 14/352,896

(22) PCT Filed: Oct. 12, 2012
(86) PCT No.: PCT/JP2012/076444

§ 371 Date: Apr. 18, 2014

(30) Foreign Application Priority Data
Oct. 19, 2011 (JP) 2011-230084
Oct. 19, 2011 (JP) 2011-230100
Oct. 19, 2011 (JP) 2011-230115
Oct. 9, 2012 (JP) 2012-224526

(51) Int. Cl. C09J 7/02

(52) U.S. Cl. CPC C09J 7/0217
USPC 428/355 AC; 524/561; 524/555; 524/104; 524/106; 524/99; 524/378; 524/266

(57) ABSTRACT

Provided is a water-dispersible acrylic pressure-sensitive adhesive composition capable of forming a pressure-sensitive adhesive layer that can prevent static build-up at the time of peeling (antistatic properties), is superior in removability, in the ability to prevent an increase in peel strength (adhesive strength) over time among the adhesive properties, as well as in appearance properties (decrease of appearance defects due to dents or the like), and also in less-staining properties on adherends, particularly, in the ability to prevent white staining on adherends in high-humidity environments (the ability to prevent white staining). The water-dispersible acrylic pressure-sensitive adhesive composition according to the invention contains an acrylic emulsion polymer containing, as monomer components, (i) an alkyl (meth)acrylate, (ii) a carboxyl group-containing unsaturated monomer, and (iii) at least one monomer selected from the group consisting of methyl methacrylate, vinyl acetate, and diethylacrylamide, and an ionic compound, and is characterized in that 70 to 99.5% by weight of the alkyl (meth)acrylate (i) is contained in the total amount of the monomer components.

### TECHNICAL FIELD

The invention relates to a water-dispersible acrylic pressure-sensitive adhesive composition capable of forming a removable pressure-sensitive adhesive layer. More specifically, the invention relates to a water-dispersible acrylic pressure-sensitive adhesive composition capable of forming a pressure-sensitive adhesive layer superior in antistatic properties, removability, and adhesive properties, reduced in appearance defects due to dents or the like, particularly excellent in appearance properties as well as superior in less-staining properties on adherends and in the ability to prevent an increase in peel strength (adhesive strength) over time. The invention also relates to a pressure-sensitive adhesive sheet including a pressure-sensitive adhesive layer made from the pressure-sensitive adhesive composition.

The present invention relates to a water-dispersible acrylic pressure-sensitive adhesive composition. More specifically, the invention relates to a water-dispersible acrylic pressure-sensitive adhesive composition capable of forming a pressure-sensitive adhesive layer superior in antistatic properties, adhesive properties, less-staining properties on adherends, and appearance properties. Still further, the invention relates to a pressure-sensitive adhesive layer made of the pressure-sensitive adhesive composition, a pressure-sensitive adhesive sheet including the pressure-sensitive adhesive layer, and an optical member to which the pressure-sensitive adhesive sheet is attached as a surface protecting film.

### BACKGROUND ART

In the process of manufacturing or processing an optical member (optical material) such as an optical film for use as a polarizing plate, a retardation plate, or an anti-reflection plate, a surface protecting film is attached to the surface of the optical member to prevent scratching, staining, or cracking of the surface or to improve cutting workability (see Patent Documents 1 and 2). Such a surface protecting film used is generally a removable pressure-sensitive adhesive sheet including a plastic film substrate and a removable pressure-sensitive adhesive layer provided on the surface of the substrate.

Traditionally, solvent-type acrylic pressure-sensitive adhesives are used in such surface protecting film applications (see Patent Documents 1 and 2). However, such solvent-type acrylic pressure-sensitive adhesives, which contain an organic solvent, are being replaced by water-dispersible acrylic pressure-sensitive adhesives in view of working environment during application (see Patent Documents 3 to 5).

While attached to optical members, such surface protecting films are required to have sufficient adhesion. In addition, such surface protecting films are required to have good peelability (removability) because they are peeled off after use in optical member-manufacturing processes or other processes. Such surface protecting films are required not only to have relatively low peel strength (light peelability) for good removability but also to have the property that its peel strength (adhesive strength) will not increase over time after it is attached to an adherend such as an optical member (the ability to prevent an increase in peel strength (adhesive strength)).

In general, surface protecting films and optical members are made of plastic materials and therefore are highly electrically insulating and can generate static electricity when they are rubbed or peeled off. Therefore, static electricity can be generated when a surface protecting film is peeled off from an optical member such as a polarizing plate, and if a voltage is applied to a liquid crystal in a state where the generated static electricity still remains, the orientation of the liquid crystal molecule may degrade, or defects may occur in the panel.

The presence of static electricity can also create a risk of attracting dust or dirt or a risk of reducing workability. To solve this problem, therefore, surface protecting films undergo various antistatic treatments.

To suppress such electrostatic build-up, an antistatic method is disclosed which includes adding a low-molecular-weight surfactant to an adhesive and transferring the surfactant from the pressure-sensitive adhesive to the object to be protected (see, for example, Patent Document 6). In this technique, however, the added low-molecular-weight surfactant can easily bleed to the surface of the pressure-sensitive adhesive, and if this technique is applied to a surface protecting film, there can be a risk of staining on an adherend (the object to be protected).

Further, in a surface protecting film (particularly, a surface protecting film for an optical member), if a pressure-sensitive adhesive layer has appearance defects such as dents, there sometimes occurs a problem such as difficulty of inspection of an adherend while the surface protecting film being bonded to the adherend. Accordingly, in the application as a surface protecting film, a pressure-sensitive adhesive sheet (pressure-sensitive adhesive layer) is required to have excellent appearance properties.

Further, in the application as a surface protecting film (particularly application as a surface protecting film for an optical member), stains on the adherend surface due to residues of the pressure-sensitive adhesive (so-called “adhesive residue”) on the surface of the adherend (optical member or the like) and transfer of a component contained in the pressure-sensitive adhesive layer to the adherend surface at the time of peeling the pressure-sensitive adhesive sheet may cause an adverse effect on optical properties of the optical member. Accordingly, a pressure-sensitive adhesive and a pressure-sensitive adhesive layer are strongly required to have less-staining properties for an adherend.

### PRIOR ART DOCUMENTS

### Patent Documents

Patent Document 1: JP-A-11-961
Patent Document 2: JP-A-2001-64607
Patent Document 3: JP-A-2001-131512
Patent Document 4: JP-A-2003-27026
Patent Document 5: Japanese Patent No. 3810490
Patent Document 6: JP-A-09-165460

### SUMMARY OF THE INVENTION

### Problems to be Solved by the Invention

As mentioned above, none of the conventional techniques can solve the problems in a well-balanced manner and in electronics-related technical fields where static build-up or staining is a particularly serious problem, it is difficult to deal with the demands for further improvement of surface protecting films with antistatic properties and others and presently, there is no water-dispersible acrylic pressure-sensitive adhesive having excellent appearance properties and removability.

It is therefore an object of the invention to provide a water-dispersible acrylic pressure-sensitive adhesive composition capable of forming a pressure-sensitive adhesive layer that can prevent static build-up at the time of peeling (antistatic properties), is superior in removability, adhesive properties, particularly in the ability to prevent an increase in peel strength (adhesive strength) over time among the adhesive properties, as well as in appearance properties (decrease of appearance defects due to dents or the like), and also in less-staining properties on adherends, particularly, in the ability to prevent white staining on adherends in high-humidity environments (the ability to prevent white staining). Still further, an object of the invention is to provide a pressure-sensitive adhesive sheet having a pressure-sensitive adhesive layer made of the pressure-sensitive adhesive composition, and an optical member to which the pressure-sensitive adhesive sheet is attached as a surface protecting film.

### Means for Solving the Problems

As a result of earnest study to achieve the objects, the inventors found that a water-dispersible acrylic pressure-sensitive adhesive composition capable of forming a pressure-sensitive adhesive layer superior in antistatic properties, removability, adhesive properties, the ability to prevent an increase in peel strength (adhesive strength), appearance properties, and less-staining properties can be obtained using, as components, an acrylic emulsion polymer obtained from raw material monomers with a specific composition and an ionic compound, and completed the invention.

Specifically, a water-dispersible acrylic pressure-sensitive adhesive composition according to the invention contains an acrylic emulsion polymer containing, as monomer components, (i) an alkyl (meth)acrylate, (ii) a carboxyl group-containing unsaturated monomer, and (iii) at least one monomer selected from the group consisting of methyl methacrylate, vinyl acetate, and diethylacrylamide, and an ionic compound, and is characterized in that 70 to 99.5% by weight of the alkyl (meth)acrylate (i) is contained in the total amount of the monomer components.

In the water-dispersible acrylic pressure-sensitive adhesive composition of the invention, the ionic compound is preferably an ionic liquid and/or an alkali metal salt.

In the water-dispersible acrylic pressure-sensitive adhesive composition of the invention, the ionic liquid is preferably a non-water-soluble ionic liquid and/or a water-soluble ionic liquid.

In the water-dispersible acrylic pressure-sensitive adhesive composition of the invention, 0.5 to 10% by weight of the monomer (ii) is preferably contained in the total amount of the monomer components.

In the water-dispersible acrylic pressure-sensitive adhesive composition of the invention, 0.5 to 10% by weight of the monomer (iii) is preferably contained in the total amount of the monomer components.

In the water-dispersible acrylic pressure-sensitive adhesive composition of the invention, the acrylic emulsion polymer is preferably obtained by polymerization using a reactive emulsifier containing a radically-polymerizable functional group in its molecule.

In the water-dispersible pressure-sensitive adhesive composition of the invention, the ionic liquid preferably contains at least one cation selected from the group consisting of cations represented by formulae (A), (B), (C), (D), and (E) below.

[chemical structure]

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

In the water-dispersible acrylic pressure-sensitive adhesive composition of the invention, the cation in the ionic liquid is preferably at least one cation selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type.

In the water-dispersible pressure-sensitive adhesive composition of the invention, the ionic liquid preferably contains one or more of cations represented by formulae (a), (b), (c), and (d) below.

[chemical structure]

In formula (a), R₁ represents hydrogen or a hydrocarbon group of 1 to 3 carbon atoms, and R₂ represents hydrogen or a hydrocarbon group of 1 to 7 carbon atoms.

In formula (b), R₃ represents hydrogen or a hydrocarbon group of 1 to 3 carbon atoms, and R₄ represents hydrogen or a hydrocarbon group of 1 to 7 carbon atoms.

In formula (c), R₅ represents hydrogen or a hydrocarbon group of 1 to 3 carbon atoms, and R₆ represents hydrogen or a hydrocarbon group of 1 to 7 carbon atoms.

In formula (d), R₇ represents hydrogen or a hydrocarbon group of 1 to 3 carbon atoms, and R₈ represents hydrogen or a hydrocarbon group of 1 to 7 carbon atoms.

In the water-dispersible acrylic pressure-sensitive adhesive composition of the invention, the alkali metal salt preferably contains a fluorine-containing anion.

In the water-dispersible acrylic pressure-sensitive adhesive composition of the invention, the alkali metal salt is preferably a lithium salt.

The water-dispersible acrylic pressure-sensitive adhesive composition of the invention preferably contains an alkylene oxide copolymer compound.

In the water-dispersible acrylic pressure-sensitive adhesive composition of the invention, the alkylene oxide copolymer compound preferably further contains a polyether antifoamer represented by the following formula (iv):

[Formula 3]

HO—(PO)ₙ₁(EO)ₘ₁—H (iv)

in the formula (iv), PO represents an oxypropylene group, EO represents an oxyethylene group, m1 represents an integer of 0 to 40, n1 represents an integer of 1 or more, and EO and PO are added in a random form or a block form.

In the water-dispersible acrylic pressure-sensitive adhesive composition of the invention, the alkylene oxide copolymer compound is preferably an organopolysiloxane represented by the following formula (vi):

[chemical structure]

wherein R₁ represents a monovalent organic group, R₂, R₃, and R₄ represent an alkylene group, R₅ represents a hydroxyl group or an organic group, m and n represent an integer of 0 to 1,000, provided that m and n are not simultaneously 0, and a and b represent an integer of 0 to 100, provided that a and b are not simultaneously 0.

The water-dispersible acrylic pressure-sensitive adhesive composition of the invention preferably further contains a non-water-soluble crosslinking agent having, in its molecule, two or more functional groups capable of reacting with a carboxyl group.

The water-dispersible acrylic pressure-sensitive adhesive composition of the invention is preferably used for removing purpose.

The pressure-sensitive adhesive layer of the invention is preferably formed by crosslinking the water-dispersible acrylic pressure-sensitive adhesive composition.

The pressure-sensitive adhesive layer of the invention is preferably formed by crosslinking with the non-water-soluble crosslinking agent.

The pressure-sensitive adhesive layer of the invention preferably contains 90% by weight or more of a solvent-insoluble component and has a breaking elongation of 160% or less at 23° C.

The pressure-sensitive adhesive sheet of the invention is preferably obtained by forming the pressure-sensitive adhesive layer on at least one surface of a support.

In the pressure-sensitive adhesive sheet of the invention, the support is preferably a plastic substrate.

The pressure-sensitive adhesive sheet of the invention is preferably used for surface protection.

The pressure-sensitive adhesive sheet of the invention is preferably used for optical use.

### Effect of the Invention

A pressure-sensitive adhesive layer (pressure-sensitive adhesive sheet) made of the water-dispersible acrylic pressure-sensitive adhesive composition of the invention has excellent antistatic properties, adhesive properties (adhesion), and removability. Particularly, it is excellent in the ability to prevent an increase in peel strength (adhesive strength) to adherends over time. Still further, it is excellent in less-staining properties, particularly, the ability to prevent white staining during storage in high-humidity environments. Since the water-dispersible acrylic pressure-sensitive adhesive composition of the present invention contains an acrylic emulsion polymer with a specific monomer composition, the obtained pressure-sensitive adhesive composition is capable of forming a pressure-sensitive adhesive layer with less appearance defects due to dents or the like and remarkably excellent appearance properties. Thus, the water-dispersible acrylic pressure-sensitive adhesive composition of the invention is particularly useful in applications of protecting the surface of optical films.

### BRIEF DESCRIPTION OF THE DRAWING

FIG. 1 is a schematic diagram of an electrical potential measuring unit.

### MODE FOR CARRYING OUT THE INVENTION

A water-dispersible acrylic pressure-sensitive adhesive composition (sometimes referred to as “pressure-sensitive adhesive composition”) according to the invention contains an acrylic emulsion polymer containing, as monomer components, (i) an alkyl (meth)acrylate, (ii) a carboxyl group-containing unsaturated monomer, and (iii) at least one monomer selected from the group consisting of methyl methacrylate, vinyl acetate, and diethylacrylamide, and an ionic compound, and is characterized in that 70 to 99.5% by weight of the alkyl (meth)acrylate (i) is contained in the total amount of the monomer components. In addition, the term “water-dispersible” refers to the ability to be dispersed in an aqueous medium, in other words, means that the pressure-sensitive adhesive composition is dispersible in an aqueous medium. The aqueous medium is a medium (dispersion medium) containing water as an essential component and may be water alone or a mixture of water and a water-soluble organic solvent. The pressure-sensitive adhesive composition of the invention may also be a dispersion containing the aqueous medium.

### [Acrylic Emulsion Polymer]

An acrylic emulsion polymer according to the invention is an acrylic emulsion polymer containing, as monomer components, (i) an alkyl (meth)acrylate, (ii) a carboxyl group-containing unsaturated monomer, and (iii) at least one monomer selected from the group consisting of methyl methacrylate, vinyl acetate, and diethylacrylamide. Herein, the term “(meth)acrylate” refers to acrylate and/or methacrylate.

The alkyl (meth)acrylate (i) is used as a principal monomer component and plays a role to produce basic properties for the pressure-sensitive adhesive (or pressure-sensitive adhesive layer), such as adhesion and peelability. In particular, alkyl acrylates tend to impart flexibility to the polymer used for forming the pressure-sensitive adhesive layer and tend to cause the effect of allowing the pressure-sensitive adhesive layer to have tackiness and adhesive properties, and alkyl methacrylates tend to impart hardness to the polymer used for forming the pressure-sensitive adhesive layer and tend to cause the effect of controlling the removability of the pressure-sensitive adhesive layer. The alkyl (meth)acrylate (i) may be, but not limited to, an alkyl (meth)acrylate having a linear, branched, or cyclic alkyl group of 2 to 16 carbon atoms (more preferably 2 to 10 carbon atoms, even more preferably 4 to 8 carbon atoms). The alkyl (meth)acrylate (i) does not include methyl methacrylate.

Especially, the alkyl acrylate is preferably an alkyl acrylate having an alkyl group of 2 to 14 carbon atoms (more preferably 4 to 9 carbon atoms), and examples of which include alkyl acrylates having a linear or branched alkyl group such as n-butyl acrylate, isobutyl acrylate, sec-butyl acrylate, isoamyl acrylate, hexyl acrylate, heptyl acrylate, octyl acrylate, 2-ethylhexyl acrylate, isooctyl acrylate, nonyl acrylate, and isononyl acrylate. In particular, 2-ethylhexyl acrylate is preferred.

For example, the alkyl methacrylate is preferably an alkyl methacrylate having an alkyl group of 2 to 16 carbon atoms (more preferably 2 to 10 carbon atoms), and examples of which include alkyl methacrylates having a linear or branched alkyl group such as ethyl methacrylate, propyl methacrylate, isopropyl methacrylate, n-butyl methacrylate, isobutyl methacrylate, sec-butyl methacrylate, and tert-butyl methacrylate; and alicyclic alkyl methacrylates such as cyclohexyl methacrylate, bornyl methacrylate, and isobornyl methacrylate.

These alkyl (meth)acrylates (i) may be appropriately selected depending on the desired adhesive properties and other properties and may be used alone or in combination of two or more.

The content of the alkyl (meth)acrylate(s) (i) is, but not limited to, from 70 to 99.5% by weight, preferably from 70 to 99% by weight, more preferably from 85 to 98% by weight, and even more preferably from 87 to 96% by weight, based on the total amount of the raw material monomer components (total amount of the monomer components: 100% by weight) used for forming the acrylic emulsion polymer according to the invention. An alkyl (meth)acrylate content of 70% by weight or more is preferable since the pressure-sensitive adhesive layer can have improved adhesion and removability. On the other hand, if the alkyl (meth)acrylate content is more than 99.5% by weight, the contents of the carboxyl group-containing unsaturated monomer (ii) and the monomer (iii) are relatively lowered, so that the pressure-sensitive adhesive layer formed by using the pressure-sensitive adhesive composition may possibly have an undesirable appearance. When two or more alkyl (meth)acrylates (i) are used, the total content (total amount) of all the alkyl (meth)acrylates (i) should be within the range.

The carboxyl group-containing unsaturated monomer (ii) can form a protecting layer on the surface of emulsion particles including the acrylic emulsion polymer according to the invention and can function to prevent shear failure of the particles. This effect can be further improved by neutralizing the carboxyl group with a base. The stability of the particles against shear failure is more generally called mechanical stability. When used in combination with one or more crosslinking agents (preferably non-water-soluble crosslinking agents in the invention) reactive with the carboxyl group, the carboxyl group-containing unsaturated monomer can act as a crosslink point at a stage where the pressure-sensitive adhesive layer is formed through removal of water. The carboxyl group-containing unsaturated monomer can also improve the tackiness (anchoring properties) to a substrate through a crosslinking agent (non-water-soluble crosslinking agent). Examples of such a carboxyl group-containing unsaturated monomer (ii) include (meth)acrylic acid (acrylic acid and methacrylic acid), itaconic acid, maleic acid, fumaric acid, crotonic acid, carboxyethyl acrylate, and carboxypentyl acrylate. The carboxyl group-containing unsaturated monomer (ii) is also intended to include acid anhydride group-containing unsaturated monomers such as maleic anhydride and itaconic anhydride. In particular, acrylic acid is preferred because it can have a relatively high concentration at the particle surface and can easily form a protecting layer with a higher density.

Examples of such a carboxyl group-containing unsaturated monomer (ii) include (meth)acrylic acid (acrylic acid and methacrylic acid), itaconic acid, maleic acid, fumaric acid, crotonic acid, carboxyethyl acrylate, and carboxypentyl acrylate. The carboxyl group-containing unsaturated monomer (ii) may also include acid anhydride group-containing unsaturated monomers such as maleic anhydride and itaconic anhydride. In particular, acrylic acid is preferred because it can have a relatively high concentration at the particle surface and can easily form a protecting layer with a higher density.

The content of the carboxyl group-containing unsaturated monomer(s) (ii) is, but not limited to, preferably from 0.5 to 10% by weight, more preferably from 1 to 6% by weight, further preferably from 1 to 5% by weight, particularly preferably from 2 to 5% by weight, and most preferably from 2 to 4% by weight, based on the total amount of the raw material monomers (total amount of the monomer components: 100% by weight) used for forming the acrylic emulsion polymer according to the invention. When the content is 10% by weight or less, an increase in the interaction between a pressure-sensitive adhesive layer and functional groups present on the surface of an adherend (object to be protected) such as a polarizing plate can be suppressed after the pressure-sensitive adhesive layer is formed, so that an increase in peel strength (adhesive strength) over time can be suppressed and peelability can be improved and thus it is preferred. If the content is more than 10% by weight, the carboxyl group-containing unsaturated monomer (ii) (such as acrylic acid), which is generally water-soluble, may be polymerized in water to cause thickening (an increase in viscosity). It is conceivable that if a large number of carboxyl groups are present in the skeleton of the acrylic emulsion polymer, the carboxyl groups can interact with the ionic compound (an ionic liquid or an alkali metal salt), which is added as an antistatic agent, so that ion conduction can be hindered and antistatic performance for the adherend may fail to be obtained, and therefore, it is not preferred. On the other hand, when the content is 0.5% by weight or more, the emulsion particles can have higher mechanical stability and therefore, it is preferred. In this case, tackiness (anchoring properties) between the pressure-sensitive adhesive layer and the support (substrate) can also increase, so that adhesive residues can be suppressed, and therefore, it is preferred.

The monomer (iii) (at least one selected from the group consisting of methyl methacrylate, vinyl acetate, and diethylacrylamide) mainly plays a role of decreasing appearance defects. These monomers (iii) are polymerized with another monomer during polymerization and the obtained polymer forms emulsion particles, so that the stability of the emulsion particles is increased and a gel (aggregates) can be decreased. When a hydrophobic non-water-soluble crosslinking agent is used, the monomer can increase the affinity to the hydrophobic non-water-soluble crosslinking agent, so that the dispersibility of the emulsion particles can be improved and the dents in the pressure-sensitive adhesive layer due to the poor dispersion can be reduced. Further, the affinity to a non-water-soluble (hydrophobic) ionic liquid is increased and the effect of suppressing staining due to the poor dispersion when the added amount of the ionic liquid is large can be improved to give a desirable embodiment.

The content of the monomer (iii) is not particularly limited, but preferably from 0.5 to 10% by weight, more preferably from 1 to 6% by weight, and further preferably from 2 to 5% by weight, based on the total amount of the raw material monomers (total amount of the monomer components: 100% by weight) used for forming the acrylic emulsion polymer according to the invention. When the content is 10% by weight or less, the polymer forming the pressure-sensitive adhesive layer becomes relatively flexible and the tackiness to adherends can be improved. Further, the appearance defects of the pressure-sensitive adhesive layer can be suppressed and thus it is preferred. On the other hand, when the content is 0.5% by weight or more, the emulsion particles can have higher mechanical stability and therefore, it is preferred. Still further, the effect caused by addition of the monomer (iii) (the effect of suppressing the appearance defects) can be sufficiently caused and thus it is preferred. The phrase “the content of the monomer (iii)” means the total of the contents (total content) of methyl methacrylate, vinyl acetate, and diethylacrylamide when two or more monomers selected from the group consisting of methyl methacrylate, vinyl acetate, and diethylacrylamide are contained in the total amount of the monomer components forming the acrylic emulsion polymer of the present invention.

As raw material monomers for forming the acrylic emulsion polymer of the invention, besides the essential monomers [the alkyl (meth)acrylate (i) the carboxyl group-containing unsaturated monomer (ii), and the monomer (iii)], another monomer component may also be used in combination for imparting a specific function. As such a monomer component, epoxy group-containing monomers such as glycidyl (meth)acrylate and polyfunctional monomers such as trimethylolpropane tri(meth)acrylate and divinylbenzene may also be added (used) each in an amount of less than 5% by weight for, for example, the purpose of internal crosslinking of the emulsion particles and improvement of the cohesive strength. The added amount (use amount) is based on the total amount of raw material monomers (total amount of the monomer components: 100% by weight) used for forming the acrylic emulsion polymer of the invention.

In terms of further reduction of white staining, it is preferable to reduce the added amount (use amount) of a hydroxyl group-containing unsaturated monomer such as 2-hydroxyethyl acrylate or 2-hydroxypropyl acrylate as another monomer component. More specifically, the content of the hydroxyl group-containing unsaturated monomer(s) is preferably less than 1% by weight, more preferably less than 0.1% by weight, and even more preferably substantially none (e.g., less than 0.05% by weight), based on the total amount of the raw material monomers (total amount of the monomer components: 100% by weight) used for forming the acrylic emulsion polymer according to the invention. In some cases, however, for the purpose of introducing a crosslink point, such as crosslink between a hydroxyl group and an isocyanate group or metal crosslink, the hydroxyl group-containing unsaturated monomer may be added (used) in an amount of about 0.01 to about 10% by weight.

The acrylic emulsion polymer according to the invention can be obtained by subjecting the raw material monomers (monomer mixture) to emulsion polymerization in the presence of an emulsifier and a polymerization initiator.

An emulsifier to be used in the emulsion polymerization is preferably a reactive emulsifier having a radically-polymerizable functional group introduced in the molecule (radically-polymerizable functional group-containing reactive emulsifier). Such emulsifiers may be used alone or in combination of two or more.

### [Reactive Emulsifier]

The radically-polymerizable functional group-containing reactive emulsifier (hereinafter, referred to as “reactive emulsifier”) is an emulsifier having at least one radically-polymerizable functional group in the molecule (per molecule). The reactive emulsifier may be, but not limited to, one or more selected from a variety of reactive emulsifiers having a radically-polymerizable functional group such as a vinyl group, a propenyl group, an isopropenyl group, a vinyl ether group (vinyloxy group), or an allyl ether group (allyloxy group). Use of the reactive emulsifier is preferable since the emulsifier can be incorporated into the polymer and staining caused by the emulsifier can be reduced.

For example, the reactive emulsifier may have a structure obtained by introducing a radially-polymerizable functional group (radially reactive group) such as a propenyl group or an allyl ether group into a nonionic-anionic emulsifier (a nonionic hydrophilic group-containing anionic emulsifier) such as sodium polyoxyethylene alkyl ether sulfate, ammonium polyoxyethylene alkyl phenyl ether sulfate, sodium polyoxyethylene alkyl phenyl ether sulfate, or sodium polyoxyethylene alkyl sulfosuccinate (or may correspond to such a structure). Hereinafter, the reactive emulsifier having a structure obtained by introducing a radically-polymerizable functional group into an anionic emulsifier will be called the “anionic reactive emulsifier.” The reactive emulsifier having a structure obtained by introducing a radically-polymerizable functional group into a nonionic-anionic emulsifier will be called the “nonionic-anionic reactive emulsifier.”

Particularly when the anionic reactive emulsifier (especially, the nonionic-anionic reactive emulsifier) is used, the emulsifier can improve the less-staining properties by being incorporated into the polymer. Particularly, when the non-water-soluble crosslinking agent according to the invention is a polyfunctional epoxy crosslinking agent having an epoxy group, the catalytic action of the reactive emulsifier can increase the reactivity of the crosslinking agent. If the anionic reactive emulsifier is not used, a crosslinking reaction may fail to stop at the stage of aging so that the problem of a change in the peel strength (adhesive strength) of the pressure-sensitive adhesive layer over time may occur. The anionic reactive emulsifier is preferred because it can be incorporated into the polymer and thus prevented from precipitating on the surface of an adherend, so that it will not cause white staining, in contrast to a quaternary ammonium compound (see, for example, JP-A-2007-31585) commonly used as a catalyst for epoxy crosslinking agents, which can precipitate on an adherend.

Such a reactive emulsifier may be a commercially available product such as ADEKA REASOAP SE-10N (trade name) manufactured by ADEKA CORPORATION, AQUALON HS-10 (trade name) manufactured by DAI-ICHI KOGYO SEIYAKU CO., LTD., and AQUALON HS-05 (trade name) manufactured by DAI-ICHI KOGYO SEIYAKU CO., LTD., and AQUALON HS-1025 (trade name) manufactured by DAI-ICHI KOGYO SEIYAKU CO., LTD.

In particular, impurity ions may cause a problem. Therefore, impurity ions should be removed, and the emulsifier to be used should preferably have an SO₄²⁻ ion concentration of 100 μg/g or less. In the case of the anionic emulsifier, an ammonium salt emulsifier is preferably used. Impurities can be removed from the emulsifier using an ion-exchange resin method, a membrane separation method, an impurity precipitation and filtration method with alcohol, or other appropriate methods.

Based on 100 parts by weight of the total amount of the raw material monomers (total amount of the monomer components) used for forming the acrylic emulsion polymer according to the invention, the added amount (use amount) of the reactive emulsifier is preferably from 0.1 to 10 parts by weight, more preferably from 0.5 to 8 parts by weight, further preferably from 1 to 7 parts by weight, still further preferably from 1 to 6 parts by weight, particularly preferably from 1 to 5 parts by weight, even more preferably from 1 to 4.5 parts by weight, and most preferably from 2 to 4.5 parts by weight. A reactive emulsifier content of 0.1 parts by weight or more is preferable in that stable emulsion can be maintained. On the other hand, a reactive emulsifier content of 10 parts by weight or less is preferable in that the solvent-insoluble component in the acrylic pressure-sensitive adhesive coating after crosslinking can be controlled within the range defined in the invention, the pressure-sensitive adhesive (pressure-sensitive adhesive layer) can have higher cohesive strength and staining on adherends can be suppressed, and the emulsifier can be prevented from causing staining.

A polymerization initiator to be used in the emulsion polymerization is not particularly limited, and examples of such a polymerization initiator include azo polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydroch loride, 2,2′-azobis(2-methylpropionamidine)disulfate, and 2,2′-azobis(N,N′-dimethyleneisobutylamidine); persulfates such as potassium persulfate and ammonium persulfate; peroxide polymerization initiators such as benzoyl peroxide and tert-butyl hydroperoxide; and redox system polymerization initiators of a combination of a peroxide and a reducing agent, such as a combination of a peroxide and ascorbic acid (e.g., a combination of hydrogen peroxide water and ascorbic acid), a combination of a peroxide and an iron (II) salt (e.g., a combination of hydrogen peroxide water and an iron (II) salt), and a combination of a persulfate and sodium hydrogen sulfite.

The added amount (use amount) of the polymerization initiator, which may be appropriately determined depending on the type of the initiator or the raw material monomers, is preferably, but not limited to, 0.01 to 1 part by weight and more preferably 0.02 to 0.5 parts by weight, based on 100 parts by weight of the total amount of the raw material monomers (total amount of the monomer components) used for forming the acrylic emulsion polymer according to the invention from the viewpoint of control of the solvent-insoluble component of the acrylic pressure-sensitive adhesive coating after crosslinking within a preferable range.

The emulsion polymerization can be performed using a conventional method by emulsifying the monomer components in water and then subjecting the emulsion to emulation polymerization. Accordingly, an aqueous dispersion (polymer emulsion) containing the acrylic emulsion polymer as a base polymer can be prepared. The emulsion polymerization method is not particularly limited, and any known emulsion polymerization method such as a batch mixing method (batch polymerization method), a monomer dropping method, or a monomer emulsion dropping method may be employed. In a monomer dropping method or a monomer emulsion dropping method, continuous dropping or intermittent dropping is appropriately selected. These methods may be combined appropriately. Reaction conditions and other conditions are appropriately selected, in which, for example, the polymerization temperature is preferably from about 40 to about 95° C., and the polymerization time is preferably from about 30 minutes to about 24 hours.

The acrylic emulsion polymer of the invention preferably has a solvent-insoluble component content (a content of solvent-insoluble components, also referred to as “gel fraction”) of 70% (% by weight) or more, more preferably 75% by weight or more, even more preferably 80% by weight or more in terms of less-staining properties and proper peel strength (adhesive strength). If the solvent-insoluble component content is less than 70% by weight, the acrylic emulsion polymer may contain a relatively large amount of low-molecular-weight components, so that only a crosslinking effect cannot sufficiently reduce the amount of low-molecular-weight components in the resulting pressure-sensitive adhesive layer and the low-molecular-weight components or the like may cause staining on adherends and may make the peel strength (adhesive strength) too high. The solvent-insoluble component content can be controlled by selecting the polymerization initiator, the reaction temperature, the emulsifier, the type of the raw material monomers, or other conditions. The upper limit of the solvent-insoluble component content is, for example, but not limited to, 99% by weight. In the invention, the solvent-insoluble component content of the acrylic emulsion polymer is the value determined by the “method for determining the solvent-insoluble component content” described below.

### (Method for Determining the Solvent-Insoluble Component Content)

About 0.1 g of the acrylic emulsion polymer is sampled and then wrapped in a porous tetrafluoroethylene sheet (NTF1122 (trade name) manufactured by NITTO DENKO CORPORATION) with an average pore size of 0.2 μm. The sheet is then tied with a kite string. The weight of the resulting product is measured and called the weight before immersion. The weight before immersion is the total weight of the acrylic emulsion polymer (sampled as mentioned above), the tetrafluoroethylene sheet, and the kite string. The total weight of the tetrafluoroethylene sheet and the kite string is also measured and called the wrapping weight. The acrylic emulsion polymer wrapped in the tetrafluoroethylene sheet and tied with the kite string (referred to as the “sample”) is then placed in a 50 ml vessel filled with ethyl acetate and allowed to stand at 23° C. for 7 days. Subsequently, the sample is taken out of the vessel (after the treatment with ethyl acetate) and transferred into an aluminum cup. The sample is dried in a dryer at 130° C. for 2 hours so that the ethyl acetate is removed. The weight of the sample is then measured and called the weight after immersion. The solvent-insoluble component content is calculated from the following formula. In the following formula, a is the weight after immersion, b is the wrapping weight, and c is the weight before immersion.

Solvent-insoluble component content (% by weight)={(a−b)/(c−b)}×100

The solvent-soluble component (also called “sol component”) of the acrylic emulsion polymer according to the invention preferably has a weight average molecular weight (Mw) of 40,000 to 200,000, more preferably 50,000 to 150,000, even more preferably 60,000 to 100,000. When the solvent-soluble component of the acrylic emulsion polymer has a weight average molecular weight of 40,000 or more, the pressure-sensitive adhesive composition can have higher wettability on the adherend and higher adhesion to the adherend. When the solvent-soluble component of the acrylic emulsion polymer has a weight average molecular weight of 200,000 or less, it is possible to reduce the amount of any residue of the pressure-sensitive adhesive composition potentially remaining on the adherend, so that the less-staining properties to the adherend can be improved. The weight average molecular weight of the solvent-soluble component of the acrylic emulsion polymer can be determined by the following process. The treatment liquid (the ethyl acetate solution) obtained after the treatment with ethyl acetate in the measurement of the solvent-insoluble component content of the acrylic emulsion polymerization is air-dried at room temperature. The resulting sample (the solvent-soluble component of the acrylic emulsion polymer) is subjected to gel permeation chromatography (GPC). More specifically, the following measurement method may be used.

### [Method for Determining Weight Average Molecular Weight (Mw)]

The GPC measurement is performed using a GPC system HLC-8220GPC manufactured by TOSOH CORPORATION to determine the polystyrene-equivalent molecular weight. The measurement conditions are as follows.

Sample concentration: 0.2% by weight (THF solution)

Sample injection volume: 10 μl

Eluent: THF

Flow rate: 0.6 ml/minute

Measurement temperature: 40° C.

Columns:

Sample columns: TSK guard column Super HZ-H×1+TSK gel Super HZM-H×2

Reference column: TSK gel Super H—RC×1

Detector: differential refractometer

### [Ionic Compound]

An ionic compound in the invention is not particularly limited, and examples thereof include ionic liquids and alkali metal salts. Examples of the ionic liquid include non-water-soluble ionic liquids and water-soluble ionic liquids. Use of the ionic compound can impart excellent antistatic performance.

### [Water-Soluble (Hydrophilic) Ionic Liquid]

The water-soluble (hydrophilic) ionic liquid in the invention is a molten salt (ionic compound) that is in a liquid state at 25° C., and those which are preferably used include, but not limited to, ionic liquids made of an organic cation component represented by any one of the following formulae (A) to (E) and an anion component, since they can impart excellent antistatic properties. When used in combination with a non-water-soluble (hydrophobic) crosslinking agent, the water-soluble (hydrophilic) ionic liquid can suppress appearance defects as compared with a non-water-soluble (hydrophobic) ionic liquid and is thus useful. In addition, a water-soluble (hydrophilic) ionic liquid may be simply referred to as an ionic liquid (ion liquid).

[chemical structure]

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₕ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation of formula (A) include a pyridinium cation, a piperidinium cation, a pyrrolidinium cation, a pyrroline skeleton-containing cation, a pyrrole skeleton-containing cation, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1-ethyl-3-hydroxymethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and an N-ethyl-N-methylmorpholinium cation.

Examples of the cation of formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-ocytl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1-(2-hydroxyethyl)-3-methylimidazolium cation, a 1-allyl-3-methylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation of formula (C) include a pyrazolium cation and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation of formula (D) include a tetraalkylammonium cation, a trialkylsulfonium cation, a tetraalkylphosphonium cation, and derivatives thereof in which part of the alkyl group is replaced by an alkenyl group, an alkoxyl group, a hydroxyl group, a cyano group, or an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, an N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, a diallyldimethylammonium cation, and a choline cation. In particular, preferably used are unsymmetrical tetraalkylammonium cations such as a triethylmethylammonium cation, a tributylethylammonium cation, a diethylmethylsulfonium cation, a dibutylethylsulfonium cation, a triethylmethylsulfonium cation, a tributylethylphosphonium cation, and a trimethyldecylphosphonium cation; a trialkylsulfonium cation, a tetraalkylphosphonium cation, an N,N-diethyl-N-methyl-N-(2-methoxyethyl)ammonium cation, a glycidyltrimethylammonium cation, a diallyldimethylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-ethyl-N-nonylammonium cation, an N,N-dimethyl-N,N-dipropylammonium cation, an N,N-diethyl-N-propyl-N-butylammonium cation, an N,N-dimethyl-N-propyl-N-pentylammonium cation, an N,N-dimethyl-N-propyl-N-hexylammonium cation, an N,N-dimethyl-N-propyl-N-heptylammonium cation, an N,N-dimethyl-N-butyl-N-hexylammonium cation, an N,N-diethyl-N-butyl-N-heptylammonium cation, an N,N-dimethyl-N-pentyl-N-hexylammonium cation, an N,N-dimethyl-N,N-dihexylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dipropyl-N,N-dihexylammonium cation, an N,N-dibutyl-N-methyl-N-pentylammonium cation, an N,N-dibutyl-N-methyl-N-hexylammonium cation, a trioctylmethylammonium cation, and an N-methyl-N-ethyl-N-propyl-N-pentylammonium cation.

For example, the cation of formula (E) may be a sulfonium cation or the like. Examples of Rₚ in formula (E) include a methyl group, an ethyl group, a propyl group, a butyl group, a hexyl group, an octyl group, a nonyl group, a decyl group, a dodecyl group, a tridecyl group, a tetradecyl group, and an octadecyl group.

In the water-dispersible acrylic pressure-sensitive adhesive composition of the invention, the cation in the ionic liquid is preferably at least one cation selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type. These ionic liquids correspond to those containing cations represented by the formulae (A), (B), and (D).

In the water-dispersible acrylic pressure-sensitive adhesive composition of the invention, the ionic liquid preferably contains at least one cation selected from the group consisting of cations represented by formulae (a) to (d) below. These cations are included in those of formulae (A) and (B).

[chemical structure]

In formula (a), R₁ represents hydrogen or a hydrocarbon group of 1 to 3 carbon atoms, preferably hydrogen or a hydrocarbon group of one carbon atom, and R₂ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (b), R₃ represents hydrogen or a hydrocarbon group of 1 to 3 carbon atoms, preferably hydrogen or a hydrocarbon group of one carbon atom, and R₄ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (c), R₅ represents hydrogen or a hydrocarbon group of 1 to 3 carbon atoms, preferably hydrogen or a hydrocarbon group of one carbon atom, and R₆ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (d), R₇ represents hydrogen or a hydrocarbon group of 1 to 3 carbon atoms, preferably hydrogen or a hydrocarbon group of one carbon atom, and R₈ represents hydrogen or a hydrocarbon group of 1 to 7 carbon atoms, preferably a hydrocarbon group of 1 to 6 carbon atoms, more preferably a hydrocarbon group of 1 to 4 carbon atoms.

On the other hand, any anion component capable of forming the water-soluble (hydrophilic) ionic liquid may be used without limitation, and examples thereof include Cl⁻, Br⁻, I⁻, BF₄⁻, PF₆⁻, ClO₄⁻, NO₃⁻, CH₃COO⁻, CF₃COO⁻, CH₃SO₃⁻, CF₃SO₃⁻, (CN)₂N⁻, C₄F₉SO₃⁻, C₃F₇COO⁻, C₂F₅SO₃⁻, C₃F₇SO₃⁻, C₄F₉SO₃⁻, (CH₃O)₂PO₂⁻, (C₂H₅O)₂PO₂⁻, CH₃OSO₃⁻, C₄H₉OSO₃⁻, C₂H₅OSO₃⁻, n-C₆H₁₃OSO₃⁻, n-C₈H₁₇OSO₃⁻, CH₃(OC₂H₄)₂OSO₃⁻, SCN⁻, HSO₄⁻, and CH₃C₆H₄SO₃⁻. In particular, fluorine atom-containing anion components are preferably used because they can form low-melting-point ionic compounds.

The water solubility of an ionic liquid can be determined by, for example, in the following manner.

### [Method for Evaluating Water Solubility]

Water (25° C.) in an amount to adjust the concentration of the ionic liquid to be 10% by weight is added and mixed using a stirrer under the conditions of a rotation speed of 300 rpm for 10 minutes. Next, after the mixture is kept still for 30 minutes, whether there is separation or clouding or not is visually confirmed, and the one for which separation and clouding cannot be observed is determined as a water-soluble (hydrophilic) ionic liquid.

Specific examples of the water-soluble (hydrophilic) ionic liquid include 1-allyl-3-butylimidazolium bromide, 1,3-diallylimidazolium bromide, 1,3-diallylimidazolium tetrafluoroborate, N,N-diethyl-N-methyl-N-(2-methoxyethyl)ammonium tetrafluoroborate, 1,3-dimethylimidazolium dimethylphosphate, 1,3-dimethylimidazolium methylsulfate, 1-ethyl-3-methylimidazolium ethylsulfate, 1-ethyl-3-methylimidazolium butysulfate, 1-ethyl-3-methylimidazolium dicyanamide, 1-ethyl-3-methylimidazolium diethylphosphate, 1-ethyl-3-methylimidazolium ethylsulfate, 1-ethyl-3-methylimidazolium hexylsulfate, 1-ethyl-3-methylimidazolium methanesulfonate, 1-ethyl-3-methylimidazolium 2-(2-methoxyethoxy)ethylsulfate, 1-ethyl-3-methylimidazolium octylsulfate, 1-ethyl-3-methylimidazolium tetrafluoroborate, 1-ethyl-3-methylimidazolium ethylthiocyanate, 1-ethyl-3-methylimidazolium p-toluenesulfonate, 1-ethyl-3-methylimidazolium trifluoroacetate, 1-ethyl-3-methylimidazolium trifluoromethanesulfonate, 1-ethyl-3-methylimidazolium perfluoroethanesulfonate, 1-ethyl-3-methylimidazolium perfluoropropaneulfonate, 1-butyl-3-methylimidazolium iodide, 1-butyl-3-methylimidazolium methanesulfonate, 1-butyl-3-methylimidazolium methylsulfate, 1-butyl-3-methylimidazolium tetrafluoroborate, 1-butyl-3-methylimidazolium trifluoroacetate, 1-butyl-3-methylimidazolium trifluoromethanesulfonate, 1-hexyl-3-methylimidazolium chloride, 1-hexyl-3-methylimidazolium bromide, 3-methyl-1-octylimidazolium bromide, 1-butylpyridinium tetrafluoroborate, 1-butylpyridinium trifluoromethanesulfonate, 1-butylpyridinium perfluoroethanesulfonate, 1-ethylpyridinium trifluoromethanesulfonate, 1-butyl-3-methylpyridinium trifluoromethanesulfonate, 1-hexylpyridinium chloride, 1-ethyl-3-methylpyridinium ethyl sulfate, 1-ethyl-3-methylpyridinium trifluoromethane sulfonate, 1-ethyl-3-methylpyridinium perfluoroethane sulfonate, 1-ethyl-3-methylpyridinium perfluoropropane sulfonate, 1-ethyl-3-methylpyridinium perfluorobutane sulfonate, 4-methyl-N-butypyridinium tetrafluoroborate, 1-ethyl-3-hydroxymethylpyridinium ethylsulfate, and 1-butyl-1-methylpyrrolidium trifluoromethanesulfonate, and they have a structural characteristic that they contain, as an anion component, Cl⁻, Br⁻, I⁻, BF₄⁻, PF₆⁻, ClO₄⁻, NO₃⁻, CH₃COO⁻, CF₃COO⁻, CH₃SO₃⁻, CF₃SO₃⁻, (CN)₂N⁻, C₄F₉SO₃⁻, C₃F₇COO⁻, C₂F₅SO₃⁻, C₃F₇SO₃⁻, C₄F₉SO₃⁻, (CH₃O)₂PO₂⁻, (C₂H₅O)₂PO₂⁻, CH₃OSO₃⁻, C₄H₉OSO₃⁻, C₂H₅OSO₃⁻, n-C₆H₁₃OSO₃⁻, n-C₈H₁₇OSO₃⁻, CH₃(OC₂H₄)₂OSO₃⁻, SCN⁻, HSO₄⁻, and CH₃C₆H₄SO₃⁻.

Further, examples of a commercially available product of the water-soluble (hydrophilic) ionic liquid include EMPES (1-ethyl-3-methylpyridinium ethyl sulfate) manufactured by Merck, CIL-313 (N-butyl-3-methylpyridinium trifluoromethanesulfonate) manufactured by Japan Carlit Co., Ltd., and EtMePy-EF11 (N-ethyl-3-methylpyridinium trifluoromethanesulfonate), EtMePy-EF21 (N-ethyl-3-methylpyridinium perfluoroethanesulfonate), EtMePy-EF31 (N-ethyl-3-methylpyridinium perfluoropropanesulfonate), EtMePy-EF41 (N-ethyl-3-methylpyridinium perfluorobutanesulfonate), EMI-EF11 (N-ethyl-3-methylimidazolium trifluoromethanesulfonate), EMI-EF21 (N-ethyl-3-methylimidazolium perfluoroethanesulfonate), EMI-EF31 (N-ethyl-3-methylimidazolium perfluoropropanesulfonate), BuPy-EF21 (N-butylpyridinium perfluoroethanesulfonate), and EtPy-EF11 (N-ethylpyridinium trifluoromethanesulfonate) manufactured by Mitsubishi Materials Corporation.

### [Non-Water-Soluble (Hydrophobic) Ionic Liquid]

The non-water-soluble (hydrophobic) ionic liquid in the present invention means a molten salt (ionic compound) that is in a liquid state at 25° C., and those which are preferably used include, but not limited to, ionic liquids made of an organic cation component represented by any one of the following formulae (A) to (E) and an anion component, since they can impart excellent antistatic properties. In addition, a non-water-soluble (hydrophobic) ionic liquid may be simply referred to as an ionic liquid (ion liquid).

[chemical structure]

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation of formula (A) include a pyridinium cation, a piperidinium cation, a pyrrolidinium cation, a pyrroline skeleton-containing cation, a pyrrole skeleton-containing cation, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and an N-ethyl-N-methylmorpholinium cation.

Examples of the cation of formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation of formula (C) include a pyrazolium cation and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation of formula (D) include a tetraalkylammonium cation, a trialkylsulfonium cation, a tetraalkylphosphonium cation, and derivatives thereof in which part of the alkyl group is replaced by an alkenyl group, an alkoxyl group, a hydroxyl group, a cyano group, or an epoxy group.

Specific examples include a tetramethylammonium cation, a tetraethylammonium cation, a tetrabutylammonium cation, a tetrapentylammonium cation, a tetrahexylammonium cation, a tetraheptylammonium cation, a triethylmethylammonium cation, a tributylethylammonium cation, an N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a tetramethylphosphonium cation, a tetraethylphosphonium cation, a tetrabutylphosphonium cation, a tetrahexylphosphonium cation, a tetraoctylphosphonium cation, a triethylmethylphosphonium cation, a tributylethylphosphonium cation, and a diallyldimethylammonium cation. In particular, preferably used are unsymmetrical tetraalkylammonium cations such as a triethylmethylammonium cation, a tributylethylammonium cation, a diethylmethylsulfonium cation, a dibutylethylsulfonium cation, a triethylmethylphosphonium cation, a tributylethylphosphonium cation, and a trimethyldecylphosphonium cation; a trialkylsulfonium cation, a tetraalkylphosphonium cation, an N,N-diethyl-N-methyl-N-(2-methoxyethyl)ammonium cation, a glycidyltrimethylammonium cation, a diallyldimethylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-ethyl-N-nonylammonium cation, an N,N-dimethyl-N,N-dipropylammonium cation, an N,N-diethyl-N-propyl-N-butylammonium cation, an N,N-dimethyl-N-propyl-N-pentylammonium cation, an N,N-dimethyl-N-propyl-N-hexylammonium cation, an N,N-dimethyl-N-propyl-N-heptylammonium cation, an N,N-dimethyl-N-butyl-N-hexylammonium cation, an N,N-diethyl-N-butyl-N-heptylammonium cation, an N,N-dimethyl-N-pentyl-N-hexylammonium cation, an N,N-dimethyl-N,N-dihexylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dipropyl-N,N-dihexylammonium cation, an N,N-dibutyl-N-methyl-N-pentylammonium cation, an N,N-dibutyl-N-methyl-N-hexylammonium cation, a trioctylmethylammonium cation, and an N-methyl-N-ethyl-N-propyl-N-pentylammonium cation.

For example, the cation of formula (E) may be a sulfonium cation or the like. Examples of Rₚ in formula (E) include a methyl group, an ethyl group, a propyl group, a butyl group, a hexyl group, an octyl group, a nonyl group, a decyl group, a dodecyl group, a tridecyl group, a tetradecyl group, and an octadecyl group.

In the water-dispersible acrylic pressure-sensitive adhesive composition of the invention, the cation in the ionic liquid is preferably at least one cation selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type. These ionic liquids correspond to those containing cations represented by the formulae (A), (B), and (D).

In the water-dispersible acrylic pressure-sensitive adhesive composition of the invention, the ionic liquid preferably contains at least one cation selected from the group consisting of cations represented by the following formulae (a) to (d). These cations are included in those of formulae (A) and (B).

[chemical structure]

In formula (a), R₁ represents hydrogen or a hydrocarbon group of 1 to 3 carbon atoms, preferably hydrogen or a hydrocarbon group of one carbon atom, and R₂ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (b), R₃ represents hydrogen or a hydrocarbon group of 1 to 3 carbon atoms, preferably hydrogen or a hydrocarbon group of one carbon atom, and R₄ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (c), R₅ represents hydrogen or a hydrocarbon group of 1 to 3 carbon atoms, preferably hydrogen or a hydrocarbon group of one carbon atom, and R₆ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (d), R₇ represents hydrogen or a hydrocarbon group of 1 to 3 carbon atoms, preferably hydrogen or a hydrocarbon group of one carbon atom, and R₈ represents hydrogen or a hydrocarbon group of 1 to 7 carbon atoms, preferably a hydrocarbon group of 1 to 6 carbon atoms, more preferably a hydrocarbon group of 1 to 4 carbon atoms.

On the other hand, any anion component capable of forming the non-water-soluble (hydrophobic) ionic liquid may be used without limitation, and examples thereof include PF₆⁻, CF₃SO₃⁻, (CF₃SO₂)₂N⁻, (CF₃SO₂)₃C⁻, (C₂F₅SO₂)₂N⁻, (CF₃SO₂)(CF₃CO)N⁻, (FSO₂)₂N⁻, (C₃F₇SO₂)₂N⁻, (C₄F₉SO₂)₂N⁻, and (C₂F₅)₃PF₃⁻. In particular, anion components having an imide structure are preferably used because they can form low-melting-point ionic compounds.

The hydrophobicity of an ionic liquid can be determined by, for example, in the following manner.

### [Method for Evaluating Non-Water-Solubility (Hydrophobicity) of Ionic Liquid]

Water (25° C.) in an amount to adjust the concentration of the ionic liquid to be 10% by weight is added and mixed using a stirrer under the conditions of a rotation speed of 300 rpm for 10 minutes. Next, after the mixture is kept still for 30 minutes, whether there is separation or clouding or not is visually confirmed, and the one for which separation and clouding can be observed is determined as a non-water-soluble (hydrophobic) ionic liquid.

Specific examples of the non-water-soluble (hydrophobic) ionic liquid include 1-butyl-3-methylpyridinium bis(trifluoromethanesulfonyl)imide, 1-butyl-3-methylpyridinium bis(pentafluoroethanesulfonyl)imide, 1-ethyl-3-hydroxymethylpyridinium bis(trifluoromethanesulfonyl)imide, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-ethyl-3-methylimidazolium bis(trifluoromethanesulfonyl)imide, 1-butyl-3-methylimidazolium bis(trifluoromethanesulfonyl)imide, 1,2-dimethyl-3-propylimidazolium bis(trifluoromethanesulfonyl)imide, 1-(2-hydroxyethyl)-3-methylimidazolium bis(trifluoromethanesulfonyl)imide, 1-allyl-3-methylimidazolium bis(trifluoromethanesulfonyl)imide, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium bis(trifluoromethanesulfonyl)imide, tetrahexylammonium bis(trifluoromethanesulfonyl)imide, tetraheptylammonium bis(trifluoromethanesulfonyl)imide, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium bis(trifluoromethanesulfonyl)imide, glycidyltrimethylammonium bis(pentafluoroethanesulfonyl)imide, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide,
N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, 1-methyl-1-propylpyrrolidinium bis(fluorosulfonyl)imide, 1-methyl-1-propylpyrrolidinium bis(fluorosulfonyl)imide, and 1-methyl-1-propylpiperidinium bis(fluorosulfonyl)imide, and they have a structural characteristic that they contain, as an anion component, bis(trifluoromethanesulfonyl)imide, bis(pentafluoroethanesulfonyl)imide, bis(fluorosulfonyl)imide, tris(trifluoromethanesulfonyl)methide, (trifluoromethanesulfonyl)trifluoroacetamide, or bis(fluorosulfonyl)imide.

Examples of a commercially available product of the non-water-soluble (hydrophobic) ionic liquid include CIL-312 (N-butyl-3-methylpyridinium bis(trifluoromethanesulfonyl)imide) manufactured by Japan Carlit Co., Ltd., and Elexcel IL-110 (1-ethyl-3-methylimidazolium bis(fluorosulfonyl)imide), Elexcel IL-120 (1-methyl-1-propylpyrrolidinium bis(fluorosulfonyl)imide), Elexcel IL-130 (1-methyl-1-propylpiperidinium bis(fluorosulfonyl)imide), Elexcel IL-210 (1-ethyl-3-methylimidazolium bis(trifluoromethanesulfonyl)imide), Elexcel IL-220 (1-methyl-1-propylpyrrolidinium bis(trifluoromethanesulfonyl)imide), and Elexcel IL-230 (1-methyl-1-propylpiperidinium bis(trifluoromethanesulfonyl)imide) manufactured by DAI-ICHI KOGYO SEIYAKU CO., LTD.

The ionic liquid (non-water-soluble ionic liquid and a water-soluble ionic liquid) described above may be a commercially available product or may be synthesized as described below. The ionic liquid may be synthesized by any method capable of producing the desired ionic liquid. In general, the ionic liquid is synthesized using methods described in the document titled “Ionic Liquids—the Front Line of Development and the Future-” published by CMC Publishing Co., Ltd., such as halide method, hydroxide method, acid ester method, complex-forming method, and neutralization method.

Hereinafter, how to synthesize nitrogen-containing onium salts by halide method, hydroxide method, acid ester method, complex-forming method, and neutralization method will be shown as an example. It will be understood that other ionic liquids such as sulfur-containing onium salts and phosphorus-containing onium salts can also be obtained by the same techniques.

Halide method is performed using the reactions represented by formulae (1) to (3) below. First, a tertiary amine and an alkyl halide are allowed to react to form a halide (reaction formula (1), the halogen used is chlorine, bromine, or iodine).

The resulting halide is allowed to react with an acid (HA) having the anion structure (A⁻) of the desired ionic liquid or to react with a salt (MA, M is a cation capable of forming a salt with the desired anion, such as ammonium, lithium, sodium, or potassium), so that the desired ionic liquid (R₄NA) is obtained.

[Formula 9]

R₃N+RX→R₄NX (X: Cl, Br, I) (1)

R₄NX+HA→R₄NA+HX (2)

R₄NX+MA→R₄NA+MX (M: NH₄, Li, Na, K, Ag, or the like) (3)

Hydroxide method is performed using the reactions represented by formulae (4) to (8). First, a halide (R₄NX) is subjected to ion exchange membrane electrolysis (reaction formula (4)), OH-type ion exchange resin method (reaction formula (5)), or reaction with silver oxide (Ag₂O) (reaction formula (6)), so that a hydroxide (R₄NOH) is obtained (the halogen used is chlorine, bromine, or iodine).

The resulting hydroxide is subjected to the reactions of formulae (7) and (8) similarly to the halide method, so that the desired ionic liquid (R₄NA) is obtained.

[Formula 10]

R₄NX+H₂O→R₄NOH+½H₂+½X₂ (X: Cl, Br, I) (4)

R₄NX+P—OH→R₄NOH+P—X (P—OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag, or the like) (8)

Acid ester method is performed using the reactions represented by formulae (9) to (11) below. First, a tertiary amine (R₃N) is allowed to react with an acid ester to form an acid ester derivative (reaction formula (9), the acid ester used is an ester of an inorganic acid such as sulfuric acid, sulfurous acid, phosphoric acid, phosphorous acid, or carbonic acid or an ester of an organic acid such as methanesulfonic acid, methylphosphonic acid, or formic acid).

The resulting acid ester derivative is subjected to the reactions of formulae (10) and (11) similarly to the halide method, so that the desired ionic liquid (R₄NA) is obtained. Alternatively, methyl trifluoromethanesulfonate, methyl trifluoroacetate, or the like may be used as the acid ester so that the ionic liquid can be directly obtained.

[chemical structure]

Complex-forming method is performed using the reactions represented by formulae (12) to (15). First, a quaternary ammonium halide (R₄NX), a quaternary ammonium hydroxide (R₄NOH), a quaternary ammonium carbonate (R₄NOCO₂CH₃), or the like is allowed to react with hydrogen fluoride (HF) or ammonium fluoride (NH₄F) to form a quaternary ammonium fluoride salt (reaction formulae (12) to (14)).

The resulting quaternary ammonium fluoride salt is subjected to a complex-forming reaction with a fluoride such as BF₃, AlF₃, PF₅, ASF₅, SbF₅, NbF₅, or TaF₅ so that an ionic liquid can be obtained (reaction formula (15)).

[formula 12]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (15)

(MFₙ₋₁=BF₃, AlF₃, PF₅, ASF₅, SbF₅, NbF₅, TaF₅, or the like)

Neutralization method is performed using the reaction represented by formula (16). A tertiary amine is allowed to react with HBF₄, HPF₆, or an organic acid such as CH₃COOH, CF₃COOH, CF₃SO₃H, (CF₃SO₂)₂NH, (CF₃SO₂)₃CH, or (C₂F₅SO₂)₂NH to form an ionic liquid.

[Formula 13]

R₃N+HZ→R₃HN⁺Z⁻ (16)

[HZ: HBF₄, HPF₆, CH₃COOH, CF₃COOH, CF₃SO₃H, An organic acid such as (CF₃SO₂)₂NH, (CF₃SO₂)₃CH, or (C₂F₅SO₂)₂NH]

In formulae (1) to (16), R represents hydrogen or a hydrocarbon group of 1 to 20 carbon atoms, and part of the hydrocarbon group may be a heteroatom-substituted functional group.

The added amount of the ionic liquid (including water-soluble and non-water-soluble ionic liquids) varies with the compatibility between the polymer and the ionic liquid to be used and is not generally specified, but based on 100 parts by weight (solid basis) of the base polymer (acrylic emulsion polymer), it is preferably 0.001 to 4.9 parts by weight, more preferably 0.01 to 3 parts by weight, even more preferably 0.03 to 2 parts by weight, and most preferably 0.05 to 1 part by weight. If the added amount is less than 0.001 parts by weight, sufficient antistatic properties may fail to be obtained, and if the added amount is more than 4.9 parts by weight, staining on adherends may tend to increase.

### [Alkali Metal Salt]

In the water-dispersible acrylic pressure-sensitive adhesive composition of the invention, an alkali metal salt, which is an ionic compound, may be used. Owing to addition of the alkali metal salt, when a pressure-sensitive adhesive layer (pressure-sensitive adhesive sheet) to be obtained is attached to an adherend (object to be protected) and then peeled off, the water-dispersible acrylic pressure-sensitive adhesive composition can impart antistatic properties to a non-antistatic adherend. The alkali metal salt is also expected to have good compatibility and well-balanced interaction with the acrylic emulsion polymer.

The alkali metal salt in the invention is not particularly limited, and examples thereof include metal salts of lithium, sodium, and potassium. More specifically, metal salts composed of a cation such as Li⁺, Na⁺, or K⁺ and an anion such as Cl⁻, Br⁻, I⁻, BF₄⁻, PF₆⁻, SCN⁻, ClO₄⁻, CF₃SO₃⁻, (CF₃SO₂)₂N⁻, (C₂F₅SO₂)₂N⁻, (CF₃SO₂)₃C⁻, C₄F₉SO₃⁻, CH₃COO⁻, C₃F₂COO⁻, (CF₃SO₂)(CF₃CO)N⁻, (FSO₂)₂N⁻, (C₄F₉SO₂)₂N⁻, (CH₃O)₂PO₂⁻, (C₂H₅O)₂PO₂⁻, (CN)₂N⁻, CH₃OSO₃⁻, C₂H₅OSO₃⁻ or n-C₈H₁₇OSO₃⁻ are preferably used. Particularly, those having a fluorine-containing anion as an anion composing the salt are preferably used. Still further, use of a lithium salt such as LiBr, LiI, LiBF₄, LiPF₆, LiSCN, LiClO₄, LiCF₃SO₃, Li(CF₃SO₂)₂N. Li(C₂F₅SO₂)₂N, or Li (CF₃SO₂)₃C is a preferable embodiment. Since a lithium salt shows a particularly high dissociation property among alkali metal salts, it is made possible to obtain a pressure-sensitive adhesive layer (pressure-sensitive adhesive sheet) excellent in antistatic properties, and to use the pressure-sensitive adhesive layer as a surface protecting film for optical members or the like which are required to have antistatic properties. These alkali metal salts may be used alone or in combination of two or more.

The added amount of an alkali metal salt used in the invention is preferably 5 parts by weight or less, more preferably 3 parts by weight or less, even more preferably 2 parts by weight or less, and most preferably 0.1 to 1 part by weight based on 100 parts by weight of a (meth)acrylic polymer. If the added amount is more than 5 parts by weight, staining on adherends (objects to be protected) tends to be increased and it is not preferred.

### [Alkylene Oxide Copolymer Compound]

The water-dispersible acrylic pressure-sensitive adhesive composition of the invention preferably contains an alkylene oxide copolymer compound. Addition of the alkylene oxide copolymer compound makes ions of the ionic compound easily movable among polyether chains with high degree of freedom and imparts an excellent antistatic effect and therefore, it is preferable. Specifically, the alkylene oxide copolymer compound may be a polyether antifoamer, an organopolysiloxane, an acetylene diol type leveling agent, etc. Especially, a polyether antifoamer and an organopolysiloxane have low surface tension and hence have high interface adsorption properties even in a small amount, so that interface adsorption is enabled in the state where the ionic compound is coordinated and excellent antistatic properties are imparted, and are thus useful.

### [Polyether Antifoamer]

The water-dispersible acrylic pressure-sensitive adhesive composition of the invention may contain the alkylene oxide copolymer compound, which is preferably a polyether antifoamer represented by the following formula (iv):

[Formula 14]

HO—(PO)ₙ₁(EO)ₘ₁—H (iv)

in the formula (iv), PO represents an oxypropylene group, EO represents an oxyethylene group, m1 represents an integer of 0 to 50, and n1 represents an integer of 1 or more. m1 is preferably 1 to 50, more preferably 1 to 30, and even more preferably 5 to 20. n1 is preferably 1 to 200, more preferably 10 to 100, and even more preferably 20 to 50. When m1 and n1 fall within the respective ranges, the composition can be less staining on adherends and it is preferred. EO and PO may be added in a random form or a block form.

In the formula (iv), PO represents an oxypropylene group, and EO represents an oxyethylene group. In the formula (iv), n1 represents an integer of 1 or more and is properly adjusted so that the PO content in the polyether antifoamer becomes 70 to 100% by weight and, for example, n1 is preferably 10 to 69. In the formula (iv), m1 represents an integer of 0 to 40 (preferably an integer of 2 to 27). In addition, when m1 is 0, the formula (iv) represents polypropylene glycol represented by HO—(PO)ₙ₁—H.

In the formula (iv), the EO and PO may be added (may be copolymerized) in a random form or a block form. In the case of addition in a block form, the arrangement of the respective blocks may be, for example, (EO block)-(PO block)-(EO block), (PO block)-(EO block)-(PO block), (EO block)-(PO block), or (PO block)-(EO block).

A compound represented by the formula (iv) is preferable since it imparts a particularly good balance between antifoaming properties and less-staining properties among the polyether antifoamers and particularly, those having a block form (block state) as the EO and PO addition form (copolymerization form) in which the respective block arrangement is (PO block)-(EO block)-(PO block) are preferable. That is, the polyether antifoamer is preferably a triblock copolymer composed of an EO block and PO blocks arranged at both ends of the EO block.

The polyether antifoamer is preferably a compound represented by the following formula (v):

[Formula 15]

HO—(PO)ₐ-(EO)_{b}—(PO)_{c}—H (v)

in the formula (v), PO represents an oxypropylene group, EO represents an oxyethylene group, a and c are each preferably an integer of 1 or more, more preferably 1 to 100, further preferably 10 to 50, and even more preferably 10 to 30. In the formula (v), a and c may be the same or different. In the formula (v), b is preferably an integer of 1 or more, more preferably 1 to 50, and even more preferably 1 to 30. If a to c fall within the respective ranges, the composition can be less staining and it is preferred.

Addition of the polyether antifoamer ((iv) and (v)) to the water-dispersible acrylic pressure-sensitive adhesive composition can remove the foam-induced defects owing to its antifoaming properties. Still further, the polyether antifoamer can bleed to the interface between the pressure-sensitive adhesive layer and the adherend to provide a release control function, which enables lightly peelable design (the less-staining properties and light peelability can be achieved by increasing the added amount of the polyether antifoamer). Because of the ether group, although the detailed reason is not clear, the use of the polyether antifoamer makes it possible to obtain good compatibility and well-balanced interaction with the ionic compound, the acrylic emulsion polymer, and the like, and it is advantageous in that the resulting surface protecting film can be less-staining on an adherend and prevented from causing static build-up on a non-antistatic adherend (object to be protected) when peeled off from the adherend.

Among the above-mentioned polyether antifoamers, the polyether antifoamer of formula (v) has a block-type structure in which the polyoxyethylene block is located at the center of the molecule and PO blocks (hydrophobic groups) are located at both ends of the molecule and therefore, this structure makes the molecule less likely to uniformly align at a gas-liquid interface and is effective to provide antifoaming properties. As compared with a PPG-PEG-PPG triblock copolymer, a PEG-PPG-PEG triblock copolymer having polyoxyethylene blocks at both ends of a molecule or a polyoxyethylene-polyoxypropylene diblock copolymer tends to uniformly align at a gas-liquid interface and thus can have a function to stabilize a foam.

The polyether antifoamer ((iv) and (v)) is highly hydrophobic and therefore is less likely to cause white staining on an adherend in high-humidity environments and can improve the less-staining properties. In high-humidity environments, a highly hydrophilic compound (especially, a water-soluble compound) can dissolve in water to become more likely to transfer to an adherend or can bleed to an adherend to swell or be whitened, and therefore can easily cause white staining.

Concerning the polyether antifoamer ((iv) and (v)), the ratio of the total weight of PO to the total weight of the polyether antifoamer [(the total weight of PO)/(the total weight of the polyether antifoamer)×100] (unit: % by weight (%)) is preferably 50 to 95% by weight, more preferably 55 to 90% by weight, and even more preferably 60 to 85% by weight. If the ratio (PO content) is less than 50% by weight, the polyether antifoamer may have high hydrophilicity so that the antifoaming properties may be lost. If the ratio is more than 95% by weight, the polyether antifoamer may have too high hydrophobicity, which may cause repellent. The term “the total weight of the polyether antifoamer” refers to the total weight of all the polyether antifoamers in the pressure-sensitive adhesive composition of the invention, and the term “the total weight of PO” refers to the total weight of PO in all the polyether antifoamers in the pressure-sensitive adhesive composition of the invention. The ratio of the total weight of PO to the total weight of the polyether antifoamer is also referred to as “PO content.” The PO content can be determined, for example, using NMR, chromatographic method (chromatography), matrix assisted laser desorption/ionization-time of flight mass spectrometry (MALDI-TOFMS), or time-of-flight secondary ion mass spectrometry (TOF-SIMS).

Concerning the polyether antifoamer, the content of propylene oxide (sometimes referred to as “PO content”) in the polyether antifoamer (100% by weight) is preferably 70 to 100% by weight, more preferably 70 to 95% by weight, further preferably 80 to 95% by weight, even more preferably 85 to 95% by weight, and most preferably 90 to 95% by weight. If the PO content is lower than 70% by weight, the staining properties on an adherend may be deteriorated. Further, in terms of less-staining properties, the PO content is preferably 95% by weight or less. The term “PO content” refers to the ratio of the total weight (% by weight) of PO (oxypropylene group) in all the polyether antifoamers to the total weight of all the polyether antifoamers contained in the water-dispersible acrylic pressure-sensitive adhesive composition of the invention. The PO content can be determined, for example, using nuclear magnetic resonance method (NMR), chromatographic method (chromatography), matrix assisted laser desorption/ionization-time of flight mass spectrometry (MALDI-TOF MS), or time-of-flight secondary ion mass spectrometry (TOF-SIMS).

In the water-dispersible acrylic pressure-sensitive adhesive composition (adhesive composition) of the invention, the polyether antifoamer preferably has a number average molecular weight of 1,200 to 4,000, more preferably 1,500 to 3,500, and even more preferably 1,750 to 3,000. If the number average molecular weight is less than 1,200, the polyether antifoamer may have too high compatibility with the system (the pressure-sensitive adhesive composition system), so that the antifoaming effect may sometimes fail to be caused and staining on an adherend may sometimes occur. On the other hand, if the number average molecular weight is more than 4,000, the antifoamer may be excessively non-compatible with the system, so that repellent may occur in the process of applying the pressure-sensitive adhesive composition to a backing or the like and staining on an adherend may sometimes occur although the antifoaming property will be improved. The number average molecular weight (Mn) is the number average molecular weight of all the polyether antifoamers contained in the water-dispersible acrylic pressure-sensitive adhesive composition of the invention. More specifically, the number average molecular weight (Mn) means the value measured by the gel permeation chromatography (GPC). Examples of a specific measurement method include techniques same as those described in [Method for determining weight average molecular weight (Mw)] described above.

The polyether antifoamer may be a commercially available product, examples of which include “Plonon #101P”, “Plonon #183”, “Plonon #201”, “Plonon #202B”, “Plonon #352”, “Unilube 10MS-250 KB”, and “Unilube 20MT-2000B” (trade names) manufactured by NOF Corporation; and “ADEKA PLURONIC L-33”, “ADEKA PLURONIC L-42”, “ADEKA PLURONIC L-43”, “ADEKA PLURONIC L-61”, “ADEKA PLURONIC L-62” (number average molecular weight: 2,200), “ADEKA PLURONIC L-71”, “ADEKA PLURONIC L-72”, “ADEKA PLURONIC L-81”, “ADEKA PLURONIC L-92”, “ADEKA PLURONIC L-101”, “ADEKA PLURONIC 17R-2” (number average molecular weight: 2,000), “ADEKA PLURONIC 17R-3”, “ADEKA PLURONIC 17R-4” (number average molecular weight: 2,500), “ADEKA PLURONIC 25R-1”, and “ADEKA PLURONIC 25R-2” (trade names) manufactured by ADEKA CORPORATION.

These polyether antifoamers may be used alone or in combination of two or more.

In the process of preparing the pressure-sensitive adhesive composition of the invention, the polyether antifoamer is preferably added by itself with no solvent and for purposes such as improvement of the workability of mixing, however, a dispersion or solution of the polyether antifoamer dispersed or dissolved in any of various solvents may also be used. Examples of the solvent include 2-ethylhexanol, butyl cellosolve, dipropylene glycol, ethylene glycol, propylene glycol, n-propyl alcohol, and isopropanol. Among these solvents, ethylene glycol is preferably used in view of dispersibility in the emulsion system.

Based on 100 parts by weight of the acrylic emulsion polymer, the added amount of the polyether antifoamer (the content in the water-dispersible acrylic pressure-sensitive adhesive composition of the invention) is preferably from 0.01 to 5 parts by weight, more preferably from 0.05 to 3 parts by weight, further preferably from 0.2 to 2 parts by weight, particularly preferably from 0.5 to 1.5 parts by weight, and most preferably from 0.6 to 1.5 parts by weight. If the content is less than 0.01 parts by weight, sufficient antifoaming properties may fail to be provided (appearance defects owing to defects of foams tend to be caused), and if the content is more than 5 parts by weight, staining on adherends may easily occur.

### [Organopolysiloxane]

The water-dispersible acrylic pressure-sensitive adhesive composition of the invention may contain the alkylene oxide copolymer compound, which is preferably an organopolysiloxane represented by the following formula (vi):

[chemical structure]

wherein R₁ represents a monovalent organic group, R₂, R₃, and R₄ represent an alkylene group, R₅ represents a hydroxyl group or an organic group, m and n represent an integer of 0 to 1,000, provided that m and n are not simultaneously 0, and a and b represent an integer of 0 to 100, provided that a and b are not simultaneously 0.

In the organopolysiloxane, it is more preferable that there are hydroxyl groups at the ends of the side chains of the polyoxyalkylene. Use of the organopolysiloxane can impart antistatic properties to an adherend (object to be protected) and is thus effective.

The added amount of the organopolysiloxane is preferably 5.0 parts by weight or less and more preferably 0.01 to 4 parts by weight based on 100 parts by weight of the acrylic emulsion polymer. If the added amount is more than 5 parts by weight, staining tends to occur and it is not preferred.

Specific examples of the organopolysiloxane include compounds represented by the formula (vi) in which R₁ is a monovalent organic group, for example, an alkyl group such as a methyl group, an ethyl group, and a propyl group; an aryl group such as a phenyl group and a tolyl group; and an aralkyl group such as a benzyl group and a phenethyl group, all of which may have a substituent such as a hydroxyl group. R₂, R₃ and R₄ may represent an alkylene group of 1 to 8 carbon atoms such as a methylene group, an ethylene group, and a propylene group. Herein, R₃ and R₄ represent different alkylene groups and R₂ may be the same as or different from R₃ or R₄. Either one of R₃ and R₄ is preferably an ethylene group or a propylene group to increase the concentration of the alkali metal salt soluble in the polyoxyalkylene side chains. R₅ may be a monovalent organic group, for example, an alkyl group such as a methyl group, an ethyl group, and a propyl group, or an acyl group such as an acetyl group and a propionyl group, which may have a substituent such as a hydroxyl group. These compounds may be used alone or in combination of two or more. Further, a reactive substituent such as a (meth)acryloyl group, an ally group, or a hydroxyl group may present in the molecule. Among the organopolysiloxanes having polyoxyalkylene side chains, organopolysiloxanes having polyoxyalkylene side chains terminated with a hydroxyl group are preferred since well-balanced compatibility can be expected.

Specific examples of the organopolysiloxane include commercially available products made available under the trade names of KF-351A, KF-353, KF-945, KF-6011, KF-889, and KF-6004 (all manufactured by Shin-Etsu Chemical Co., Ltd.), FZ-2122, FZ-2164, FZ-7001, SH8400, SH8700, SF8410, and SF8422 (all manufactured by Dow Corning Toray Co., Ltd.), TSF-4440, TSF-4445, TSF-4452, and TSF-4460 (manufactured by Momentive Performance Materials Inc.), and BYK-333, BYK-377, BYK-UV3500, and BYK-UV3570 (manufactured by BYK Japan KK). These compounds may be used alone or in combination of two or more.

In order to further improve the defoaming effect, the water-dispersible acrylic pressure-sensitive adhesive composition of the invention may contain a polyoxyalkylene compound (sometimes referred to as “another polyoxyalkylene compound”) other than the polyether antifoamer. Examples of another polyoxyalkylene compound include reaction products of a monoalcohol of 4 to 18 carbon atoms (butyl alcohol, isoamyl alcohol, n-amyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, etc.), a monocarboxylic acid of 4 to 18 carbon atoms (butyric acid, valeric acid, capric acid, enanthic acid, caprylic acid, pelargonic acid, undecyl acid, lauric acid, tridecyl acid, myristic acid, pentadecyl acid, palmitic acid, heptadecyl acid, stearic acid, etc.), or a monoamine of 4 to 18 carbon atoms (butylamine, octylamine, laurylamine, stearylamine, etc.) with an alkylene oxide of 2 or 4 carbon atoms; formalin condensates of a polyol of 3 to 60 carbon atoms [glycerin, trimethylolpropane, trimethylolbutane, pentaerythritol, phenol or alkyl phenol (octylphenol, nonylphenol, butylphenol, etc.); and reaction products of a saccharide (glycoside, sucrose, iso-saccharose, trehalose, iso-trehalose, gentianose, melicitose, planteose, raffinose, etc.) with an alkylene oxide of 2 or 4 carbon atoms.

Based on 100 parts by weight of the polyether antifoamer, the content of another polyoxyalkylene compound is preferably 100 parts by weight or less, more preferably from 1 to 70 parts by weight, even more preferably from 3 to 50 parts by weight, and most preferably from 5 to 30 parts by weight.

From the viewpoint of less-staining properties, it is preferable for the water-dispersible acrylic pressure-sensitive adhesive composition of the invention that no quaternary ammonium salt to be used as a crosslinking agent is added, and it is more preferable that no quaternary ammonium compound is added. Consequently, the water-dispersible acrylic pressure-sensitive adhesive composition of the invention preferably contains substantially no quaternary ammonium salt and more preferably contains substantially no quaternary ammonium compound. These compounds are generally used as a catalyst or the like for improving the reactivity of an epoxy crosslinking agent. However, since being not taken in the polymer forming a pressure-sensitive adhesive layer and freely movable in the pressure-sensitive adhesive layer, these compounds tend to be precipitated on the adherend surface. In the case where these compounds are contained in the pressure-sensitive adhesive composition, white staining tends to be caused easily and thus the less-staining properties may not be achieved. More specifically, the content of the quaternary ammonium salt in the water-dispersible acrylic pressure-sensitive adhesive composition of the invention is preferably less than 0.1% by weight, more preferably less than 0.01% by weight, and even more preferably less than 0.005% by weight, based on 100% by weight of the pressure-sensitive adhesive composition (nonvolatile components). Further, the content of the quaternary ammonium compound preferably satisfies the above-mentioned range.

It is preferable that no crosslinking catalyst is added, but a quaternary ammonium salt to be used if necessary may be, for example, an alkylammonium hydroxide or a salt thereof such as tetramethylammonium hydroxide (TMAH), tetraethylammonium hydroxide, tetrapropylammonium hydroxide, or tetrabutylammonium hydroxide; an arylammonium hydroxide or a salt thereof such as tetraphenylammonium hydroxide; or a base or a salt thereof having, as a cation, a trilaurylmethylammonium ion, a didecyldimethylammonium ion, a dicocoildimethylammonium ion, a distearyldimethylammonium ion, a dioleyldimethylammonium ion, a cetyltrimethylammonium ion, a stearyltrimethylammonium ion, a behenyltrimethylammonium ion, a cocoilbis(2-hydroxyethyl)methylammonium ion, a polyoxyethylene(15)cocostearylmethylammonium ion, an oleylbis(2-hydroxyethyl)methylammonium ion, a cocobenzyldimethylammonium ion, a laurylbis(2-hydroxyethyl)methylammonium ion, a decylbis(2-hydroxyethyl)methylammonium ion, or a derivative of the above-mentioned compounds.

[Crosslinking Agent]

In the water-dispersible acrylic pressure-sensitive adhesive composition of the invention, the acrylic emulsion polymer can give a pressure-sensitive adhesive layer and a pressure-sensitive adhesive sheet excellent in heat resistance and weather resistance by appropriately crosslinking the acrylic emulsion polymer. A specific means for a crosslinking method is not particularly limited, and a non-water-soluble crosslinking agent is particularly preferably used mainly in terms of obtaining a suitable level of cohesive strength. In the invention, an isocyanate compound, an epoxy compound, a melamine resin, an aziridine derivative, a metal chelate compound, or the like may be used as the crosslinking agent. In particular, an isocyanate compound or an epoxy compound is preferably used mainly to achieve a suitable level of cohesive strength. These compounds may be used alone or in combination of two or more.

### [Non-Water-Soluble Crosslinking Agent]

The non-water-soluble crosslinking agent of the invention is a non-water-soluble compound having, in the molecule (per molecule), two or more (e.g., two to six) functional groups capable of reacting with carboxyl groups. The number of functional groups capable of reacting with carboxyl groups is preferably three to five per molecule. As the number of functional groups capable of reacting with carboxyl groups increases per molecule, the pressure-sensitive adhesive composition can be crosslinked more densely (in other words, the polymer used for forming a pressure-sensitive adhesive layer can have a dense crosslinked structure). This makes it possible to prevent the pressure-sensitive adhesive layer from wet-spreading after it is formed. In addition, the polymer used for forming the pressure-sensitive adhesive layer can be constrained, so that the functional groups (carboxyl groups) in the pressure-sensitive adhesive layer can be prevented from segregating to the surface of an adherend, which makes it possible to prevent the peel strength (adhesive strength) between the pressure-sensitive adhesive layer and the adherend from increasing over time. On the other hand, if the number of functional groups capable of reacting with carboxyl groups is too large or more than six per molecule, a gel may be formed.

In the non-water-soluble crosslinking agent according to the invention, the functional group capable of reacting with carboxyl groups is not particularly limited and may be, for example, an epoxy group, an isocyanate group, a carbodiimide group, or the like. In particular, an epoxy group is preferred in view of reactivity. A glycidylamino group is more preferred because it is highly reactive so that unreacted substances hardly remain during the crosslinking reaction and it is advantageous for less-staining properties and effective for preventing unreacted carboxyl groups in the pressure-sensitive adhesive layer from increasing the peel strength (adhesive strength) between the pressure-sensitive adhesive layer and the adherend over time. Specifically, the non-water-soluble crosslinking agent according to the invention is preferably an epoxy crosslinking agent having an epoxy group, more preferably a crosslinking agent having a glycidylamino group (glycidylamino-containing crosslinking agent). When the non-water-soluble crosslinking agent according to the invention is an epoxy crosslinking agent (especially, a glycidylamino-containing crosslinking agent), the number of epoxy groups (especially, glycidylamino groups) per molecule is preferably two or more (e.g., two to six), more preferably three to five.

In the invention, the non-water-soluble crosslinking agent is a compound insoluble in water. The term “non-water-soluble” means that the solubility in 100 parts by weight of water at 25° C. (the weight of the compound (crosslinking agent) soluble in 100 parts by weight of water) is 5 parts by weight or less, preferably 3 parts by weight or less, more preferably 2 parts by weight or less. When the non-water-soluble crosslinking agent is used, any residue of the crosslinking agent, not undergoing crosslinking, hardly causes white staining on the adherend in high-humidity environments, so that the less-staining properties can be improved. If a water-soluble crosslinking agent is used, any residue of the crosslinking agent can dissolve in water and easily transfer onto the adherend in high-humidity environments, so that it can easily cause white staining. As compared with a water-soluble crosslinking agent, a non-water-soluble crosslinking agent can highly contribute to the crosslinking reaction (the reaction with carboxyl groups) and be highly effective in preventing the increase in peel strength (adhesive strength) over time. In addition, the non-water-soluble crosslinking agent, being highly reactive for the crosslinking reaction, can rapidly undergo the crosslinking reaction during aging, so that unreacted carboxyl groups in the pressure-sensitive adhesive layer can be prevented from increasing the peel strength (adhesive strength) between the pressure-sensitive adhesive layer and the adherend over time. Herein, the solubility of the crosslinking agent in water can be determined as follows, for example.

### [Method for Determining the Solubility in Water]

The same weights of water (25° C.) and the crosslinking agent are mixed using a stirrer under the conditions of a rotation speed of 300 rpm and 10 minutes and the mixture is separated into a water phase and an oil phase by centrifugation. The water phase is then collected and dried at 120° C. for 1 hour, and the amount of the non-volatile component in the water phase (the parts by weight of the non-volatile component based on 100 parts by weight of water) is determined from the weight loss on drying.

Specific examples of the non-water-soluble crosslinking agent for the invention include glycidylamino-containing crosslinking agents such as 1,3-bis(N,N-diglycidylaminomethyl)cyclohexane (such as TETRAD-C (trade name) manufactured by MITSUBISHI GAS CHEMICAL COMPANY, INC. (with a solubility of 2 parts by weight or less in 100 parts by weight of water at 25° C.)) and 1,3-bis(N,N-diglycidylaminomethyl)benzene (such as TETRAD-X (trade name) manufactured by MITSUBISHI GAS CHEMICAL COMPANY, INC. (with a solubility of 2 parts by weight or less in 100 parts by weight of water at 25° C.)); and other epoxy crosslinking agents such as tris(2,3-epoxypropyl)isocyanurate (such as TEPIC-G (trade name) manufactured by NISSAN CHEMICAL INDUSTRIES, LTD. (with a solubility of 2 parts by weight or less in 100 parts by weight of water at 25° C.)). These non-water-soluble crosslinking agents may be used alone or in combination of two or more.

In the invention, the content of the non-water-soluble crosslinking agent (the content in the water-dispersible acrylic pressure-sensitive adhesive composition of the invention) is preferably such that the number of moles of the functional group of the non-water-soluble crosslinking agent which is capable of reacting with a carboxyl group is from 0.1 to 1.3 moles and more preferably from 0.2 to 1.3 moles per mole of the carboxyl group of the carboxyl group-containing unsaturated monomer (ii) used as a raw material monomer for forming the acrylic emulsion polymer according to the invention. In other words, the ratio of “the total number of moles of the functional groups of the non-water-soluble crosslinking agent of the invention which are capable of reacting with the carboxyl group” to “the total number of moles of the carboxyl groups of all the carboxyl group-containing unsaturated monomers (ii) used as raw material monomers for forming the acrylic emulsion polymer of the invention, that is, [the functional groups capable of reacting with the carboxyl groups/carboxyl groups] (molar ratio) is preferably from 0.1 to 1.3, more preferably from 0.2 to 1.3, further preferably from 0.3 to 1.1, and even more preferably from 0.3 to 1.0. A molar ratio of [the functional groups capable of reacting with the carboxyl groups/the carboxyl groups] of 0.1 or more is advantageous in that the amount of unreacted carboxyl groups in the pressure-sensitive adhesive layer can be reduced and that an increase in peel strength (adhesive strength) over time, which is caused by the interaction between the carboxyl groups and an adherend, can be effectively prevented. Further, it is preferable since the solvent-insoluble components of acrylic pressure-sensitive adhesive coating after crosslinking and breaking elongation can be easily controlled in the ranges defined according to the invention. A molar ratio of 1.3 or less is advantageous in that the amount of the unreacted non-water-soluble crosslinking agent in the pressure-sensitive adhesive layer can be reduced and that the non-water-soluble crosslinking agent can be suppressed from causing appearance defects so that appearance characteristics can be improved.

Particularly when the non-water-soluble crosslinking agent of the invention is an epoxy crosslinking agent, the molar ratio of [the epoxy group/the carboxyl group] is preferably from 0.2 to 1.3, more preferably from 0.3 to 1.1, and even more preferably from 0.3 to 1.0. Also when the non-water-soluble crosslinking agent of the invention is a glycidylamino-containing crosslinking agent, the molar ratio of [the glycidylamino group/the carboxyl group] preferably falls within the above-mentioned range.

For example, when 4 g of a non-water-soluble crosslinking agent with a functional group equivalent of the functional group capable of reacting with a carboxyl group of 110 (g/eq) is added to (or mixed in) the pressure-sensitive adhesive composition, the number of moles of the functional group capable of reacting with the carboxyl group in the non-water-soluble crosslinking agent can be typically calculated as follows.

The number of moles of the functional group in the non-water-soluble crosslinking agent which is capable of reacting with the carboxyl group=[the mixed amount of the non-water-soluble crosslinking agent (the added amount)]/[the functional group equivalent]=4/110

For example, when 4 g of an epoxy crosslinking agent with an epoxy equivalent of 110 (g/eq) is added to (or mixed in) as the non-water-soluble crosslinking agent, the number of moles of the epoxy group in the epoxy crosslinking agent can be typically calculated as follows.

The number of moles of the epoxy group in the epoxy crosslinking agent=[the mixed amount of the epoxy crosslinking agent (the added amount)]/[the epoxy equivalent]=4/110

The water-dispersible acrylic pressure-sensitive adhesive composition of the invention may contain a crosslinking agent (another crosslinking agent) other than the above-mentioned non-water-soluble crosslinking agent. Another crosslinking agent is not particularly limited, and preferably a polyfunctional hydrazide crosslinking agent. Use of a polyfunctional hydrazide crosslinking agent can improve the removability of the pressure-sensitive adhesive layer formed using the pressure-sensitive adhesive composition, adhesive properties (adhesion) and anchoring properties on a support (substrate). The polyfunctional hydrazide crosslinking agent (sometimes referred to simply as “hydrazide crosslinking agent”) is a compound having at least two hydrazide groups in its molecule (per molecule). The number of hydrazide groups per molecule is preferably two or three and more preferably two. The compound used as the hydrazide crosslinking agent is not particularly limited, and examples thereof include dihydrazide compounds such as oxalic acid dihydrazide, malonic acid dihydrazide, succinic acid dihydrazide, glutaric acid dihydrazide, adipic acid dihydrazide, pimelic acid dihydrazide, suberic acid dihydrazide, azelaic acid dihydrazide, sebacic acid dihydrazide, dodecandioic acid dihydrazide, phthalic acid dihydrazide, isophthalic acid dihydrazide, terephthalic acid dihydrazide, 2,6-naphthalenedicarboxylic acid dihydrazide, naphthalic acid dihydrazide, acetonedicarboxylic acid dihydrazide, fumaric acid dihydrazide, maleic acid dihydrazide, itaconic acid dihydrazide, trimellitic acid dihydrazide, 1,3,5-benzenetricarboxylic acid dihydrazide, pyromellitic acid dihydrazide, and aconitic acid dihydrazide. Among them, particularly preferred are adipic acid dihydrazide and sebacic acid dihydrazide. These hydrazide crosslinking agents may be used alone or in combination of two or more.

Commercially available products may be used as the hydrazide crosslinking agent and, for example, Adipic acid dihydrazide (reagent) manufactured by Tokyo Chemical Industry Co., Ltd., and Adipoyl dihydrazide (reagent) manufactured by Wako Pure Chemical Industries, Ltd. are usable.

Based on 1 mole of the keto group of the keto group-containing unsaturated monomer used as the raw material monomer for the acrylic emulsion polymer, the added amount of the hydrazide crosslinking agent (the content in the water-dispersible acrylic pressure-sensitive adhesive composition of the invention) is preferably from 0.025 to 2.5 moles, more preferably from 0.1 to 2 moles, and even more preferably from 0.2 to 1.5 moles. If the added amount is less than 0.025 moles, the effect of crosslinking agent addition is so slight that the pressure-sensitive adhesive layer or pressure-sensitive adhesive sheet may be tough to peel off and leave low-molecular-weight components in the polymer forming the pressure-sensitive adhesive layer, and it may result in white staining easily caused on an adherend. If the added amount exceeds 2.5 moles, the unreacted crosslinking agent component may sometimes cause staining.

### [Water-Dispersible Acrylic Pressure-Sensitive Adhesive Composition]

As described above, the water-dispersible acrylic pressure-sensitive adhesive composition (pressure-sensitive adhesive composition) of the invention contains, as essential components, the acrylic emulsion polymer and the ionic compound of the invention. If necessary, the composition may contain various kinds of other additives.

In a preferred mode, the water-dispersible acrylic pressure-sensitive adhesive composition of the invention is substantially free of so-called nonreactive (non-polymerizable) components (except water and other components that are evaporated by drying and do not remain in the pressure-sensitive adhesive layer after drying) other than reactive (polymerizable) components capable of being incorporated into the polymer forming the pressure-sensitive adhesive layer by reaction on (polymerization with) the raw material monomers, etc., of the acrylic emulsion polymer. If nonreactive components remain in the pressure-sensitive adhesive layer, these components may transfer to an adherend to cause white staining. The term “substantially free of” means that the components are not intentionally added and may be contained as inevitable contaminants. Specifically, the content of such nonreactive components in the pressure-sensitive adhesive composition (nonvolatile components) is preferably less than 1% by weight, more preferably less than 0.1% by weight, and even more preferably less than 0.005% by weight.

Examples of such nonreactive components include components capable of bleeding to the surface of the pressure-sensitive adhesive layer and imparting peelability, such as phosphate ester compounds disclosed in JP-A-2006-45412. Examples also include nonreactive emulsifiers such as sodium lauryl sulfate and ammonium lauryl sulfate.

The water-dispersible acrylic pressure-sensitive adhesive composition of the invention may contain various additives other than the above as long as the less-staining properties are not affected. Examples of such additives include pigments, fillers, leveling agents, dispersing agents, plasticizers, stabilizers, antioxidants, ultraviolet absorbers, ultraviolet stabilizers, age resisters, and preservatives.

As a mixing method for forming the water-dispersible acrylic pressure-sensitive adhesive composition of the invention, known conventional mixing methods for forming an emulsion can be employed without any particular limitation, and stirring using a stirrer is preferable. Although not particularly limited, the stirring condition is preferably a temperature of 10 to 50° C., more preferably 20 to 35° C. The stirring time is preferably from 5 to 30 minutes, more preferably from 10 to 20 minutes. The rotation speed is preferably from 10 to 3,000 rpm, more preferably from 30 to 1,000 rpm.

[Solvent-Insoluble Component Content of Acrylic Pressure-Sensitive Adhesive Coating after Crosslinking]

The coating formed by applying the water-dispersible acrylic pressure-sensitive adhesive composition of the invention in such a manner as to give a thickness of 50 μm after drying, thereafter drying the water-dispersible acrylic pressure-sensitive adhesive composition at 120° C. for 2 minutes and aging it at 50° C. for 3 days (“acrylic pressure-sensitive adhesive coating after crosslinking,” or sometimes simply referred to as “coating”) preferably has a solvent-insoluble component content (gel fraction) of 90% (% by weight) or more, more preferably 95% by weight or more in terms of less-staining properties and removability improvement. If the solvent-insoluble component content in the coating is 90% by weight or more, the pressure-sensitive adhesive composition can be crosslinked to a sufficiently high crosslinking degree and therefore, when a pressure-sensitive adhesive layer (pressure-sensitive adhesive sheet) is formed, transfer of the staining materials to an adherend can be reduced and the white staining can be suppressed. Further, the pressure-sensitive adhesive sheet is prevented from becoming tough to peel off and the removability can be improved. The upper limit of the solvent-insoluble component content of the coating is not particularly limited and preferably, for example, 99% by weight. The solvent-insoluble component content in the acrylic pressure-sensitive adhesive coating after crosslinking can be measured by the same method as the method for measuring the solvent-insoluble component content in the acrylic emulsion polymer. Specifically, the measurement can be preformed by the above-mentioned method for measuring solvent-insoluble component content in which the phrase “acrylic emulsion polymer” may read as “acrylic pressure-sensitive adhesive coating after crosslinking.”

The coating (acrylic pressure-sensitive adhesive coating after crosslinking) formed by applying the water-dispersible acrylic pressure-sensitive adhesive composition of the invention in such a manner as to give a thickness of 50 μm after drying, thereafter drying the water-dispersible acrylic pressure-sensitive adhesive composition at 120° C. for 2 minutes and aging it at 50° C. for 3 days has a breaking elongation (also referred to as “elongation at breaking point”) of 160% or less, preferably 40 to 120%, and more preferably 60 to 115% at 23° C. The breaking elongation (elongation at breaking point) is an index of the crosslinking degree of the coating in the case of crosslinking the pressure-sensitive adhesive composition, and if it is 160% or less, the crosslinking structure of the polymer forming the pressure-sensitive adhesive layer is dense. Consequently, wet-spreading of the pressure-sensitive adhesive layer can be prevented after it is formed. In addition, the polymer used for forming the pressure-sensitive adhesive layer can be constrained, so that the functional groups (carboxyl groups) in the pressure-sensitive adhesive layer can be prevented from segregating to the surface of the adherend and an increase in the peel strength (adhesive strength) between the pressure-sensitive adhesive layer and the adherend can be prevented from increasing over time.

The breaking elongation (elongation at breaking point) at 23° C. of the acrylic pressure-sensitive adhesive coating after crosslinking can be measured by a tensile test. Although not particularly limited, more specifically, the elongation at breaking point can be measured by producing a cylindrical sample (length 50 mm, cross-sectional area (bottom area) 1 mm²) by rolling the coating, and carrying out a tensile test using a tensile tester in an environment of 23° C. and 50% RH under the conditions of an initial length (chuck distance) of 10 mm and a tension speed of 50 mm/min.

The acrylic pressure-sensitive adhesive coating after crosslinking is more specifically produced by, for example, the following “Production of acrylic pressure-sensitive adhesive coating after crosslinking.”

[Production of Acrylic Pressure-Sensitive Adhesive Coating after Crosslinking]

The crosslinked coating (acrylic pressure-sensitive adhesive coating after crosslinking) is of the water-dispersible acrylic pressure-sensitive adhesive composition of the invention is produced by applying the water-dispersible acrylic pressure-sensitive adhesive composition of the invention to a proper release film in such a manner as to give a thickness of 50 μm after drying, thereafter drying the water-dispersible acrylic pressure-sensitive adhesive composition at 120° C. for 2 minutes in a hot air circulating oven and aging it at 50° C. for 3 days. The release film is not particularly limited and, for example, a PET film surface treated with silicone can be used, and examples of commercially available products include MRF 38 manufactured by Mitsubishi Plastics, Inc.

### [Pressure-Sensitive Adhesive Layer and Pressure-Sensitive Adhesive Sheet]

The pressure-sensitive adhesive layer (pressure-sensitive adhesive sheet) of the invention is formed using the removable water-dispersible acrylic pressure-sensitive adhesive composition. A method for forming the pressure-sensitive adhesive layer may be a conventionally known method for forming a pressure-sensitive adhesive layer without limitation. The pressure-sensitive adhesive layer can be formed by a process including applying the pressure-sensitive adhesive composition onto a support (substrate) or a release film (release liner) and then drying the composition. When the pressure-sensitive adhesive layer is formed on the release (separator) film, the pressure-sensitive adhesive layer is attached to a support (substrate) and transferred.

In the process of forming the pressure-sensitive adhesive layer (pressure-sensitive adhesive sheet), the drying temperature is generally from about 80 to about 170° C., preferably from 80 to 160° C., and the drying time is generally from about 0.5 to about 30 minutes, preferably from 1 to 10 minutes. Subsequently, curing (aging) should be further performed at room temperature to about 50° C. for 1 day to 1 week, when the pressure-sensitive adhesive layer (pressure-sensitive adhesive sheet) is prepared.

Any of various methods may be used in the step of applying the pressure-sensitive adhesive composition. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness (thickness after drying) of the pressure-sensitive adhesive layer is generally set in the range of about 1 to about 100 μm, preferably in the range of 5 to 50 μm, and more preferably in the range of 10 to 40 μm.

Examples of the material used to form the release film include a plastic film such as a polyethylene, polypropylene, polyethylene terephthalate, or polyester film, a porous material such as paper, cloth, or nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The thickness of the release film is generally from about 5 to about 200 μm, preferably from about 5 to about 100 μm.

If necessary, the release film may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further improved.

When the pressure-sensitive adhesive layer is exposed, the pressure-sensitive adhesive layer may be protected by the release film until it is actually used. The release film may be used by itself as a separator for the pressure-sensitive adhesive-type optical film, so that the process can be simplified.

The pressure-sensitive adhesive layer preferably has a solvent-insoluble component content (gel fraction) of 90% (% by weight) or more and more preferably 95% by weight or more, similarly to the above-mentioned acrylic pressure-sensitive adhesive coating after crosslinking.

Similarly to the above-mentioned acrylic pressure-sensitive adhesive coating after crosslinking, the pressure-sensitive adhesive layer preferably has a breaking elongation (elongation at breaking point) at 23° C. of 160% or less, more preferably 40 to 160%, further preferably 40 to 150%, still more preferably 60 to 150%, even more preferably 40 to 120%, and most preferably 60 to 115%.

The acrylic polymer (after crosslinking) forming the pressure-sensitive adhesive layer preferably has a glass transition temperature (Tg) of −70 to −10° C., more preferably −70 to −20° C., even more preferably −70 to −40° C., and most preferably −70 to −50° C. The acrylic polymer with a glass transition temperature of higher than −10° C. may have insufficient adhesive strength so that it may lift or peel during working or processing. The acrylic polymer with a glass transition temperature of lower than −70° C. may be tough to peel off in a high peel rate (tension speed) region, which may decrease work efficiency. For example, the glass transition temperature of the polymer (after crosslinking) forming the pressure-sensitive adhesive layer can also be controlled by the composition of the monomers in the preparation of the acrylic emulsion polymer according to the invention.

Formation of the pressure-sensitive adhesive layer (the pressure-sensitive adhesive layer formed using the water-dispersible acrylic pressure-sensitive adhesive composition of the invention) on at least one surface of a support (also referred to as “substrate” or “supporting substrate”) gives a pressure-sensitive adhesive sheet (a substrate-attached pressure-sensitive adhesive sheet or a pressure-sensitive adhesive sheet having the pressure-sensitive adhesive layer formed using the water-dispersible acrylic pressure-sensitive adhesive composition of the invention on at least one surface of a substrate). The pressure-sensitive adhesive layer formed using the water-dispersible acrylic pressure-sensitive adhesive composition of the invention may be used by itself as a substrate-less pressure-sensitive adhesive sheet. Hereinafter, the substrate-attached pressure-sensitive adhesive sheet may be referred to as “the pressure-sensitive adhesive sheet of the invention.”

The pressure-sensitive adhesive sheet (the above-mentioned substrate-attached pressure-sensitive adhesive sheet) of the invention can be obtained, for example, by a process including applying the water-dispersible acrylic pressure-sensitive adhesive composition of the invention to at least one surface of a support (substrate) and drying the composition if necessary to form a pressure-sensitive adhesive layer on at least one surface of the support (direct coating process). Crosslinking may be performed by subjecting the pressure-sensitive adhesive sheet to heating or the like after dehydration or drying in the drying step. Alternatively, the pressure-sensitive adhesive sheet can be obtained by a process including once forming the pressure-sensitive adhesive layer temporarily on a release film and then transferring the pressure-sensitive adhesive layer onto a support (transfer process). Although not particularly limited, the pressure-sensitive adhesive layer is preferably formed by what is called a direct coating process of applying the pressure-sensitive adhesive composition directly to the surface of a support. Since the solvent-insoluble component content of the pressure-sensitive adhesive layer of the invention is high, it may be sometimes impossible to obtain sufficient anchoring properties (tackiness) to the support by the transfer process.

The support (substrate) for the pressure-sensitive adhesive sheet of the invention is preferably a plastic substrate (such as a plastic film or a plastic sheet) so that a highly transparent pressure-sensitive adhesive sheet can be obtained. Examples of materials for the plastic substrate include, but are not limited to, polyolefins (polyolefin resins) such as polypropylene and polyethylene, polyesters (polyester resins) such as polyethylene terephthalate (PET), and other transparent resins such as polycarbonate, polyamide, polyimide, acrylic, polystyrene, acetate, polyether sulfone, and triacetylcellulose. These resins may be used singly or in combination of two or more. Among the substrate materials, polyester resins or polyolefin resins are preferably used, and PET, polypropylene, and polyethylene are more preferably used in view of productivity and formability, although the substrate materials are not limited to such materials. Specifically, the support (substrate) is preferably a polyester-based film or a polyolefin-based film, more preferably a PET film, a polypropylene film, or a polyethylene film. The polypropylene may be, but not limited to, a homopolymer (homo-type), an α-olefin random copolymer (random type), or an α-olefin block copolymer (block type). The polyethylene may be low density polyethylene (LDPE), high density polyethylene (HDPE), or linear low density polyethylene (L-LDPE). These may be used singly or in combination of two or more.

The thickness of the support is preferably, but not limited to, 10 to 150 μm, more preferably 30 to 100 μm.

In order to improve adhesive strength to the pressure-sensitive adhesive layer, the surface of the support, on which the pressure-sensitive adhesive layer is to be provided, is preferably subjected to an adhesion-facilitating treatment such as an acid treatment, an alkali treatment, a primer treatment, a corona treatment, a plasma treatment, or an ultraviolet ray treatment. An intermediate layer may also be formed between the support and the pressure-sensitive adhesive layer. The thickness of the intermediate layer is, for example, preferably from 0.01 to 1 μm, more preferably from 0.05 to 1 μm, and even more preferably from 0.1 to 1 μm.

The pressure-sensitive adhesive sheet of the invention may be wound into a roll with the pressure-sensitive adhesive layer being protected by the release film (separator). The back surface of the pressure-sensitive adhesive sheet (the surface opposite to the side on which the pressure-sensitive adhesive layer is provided) may be subjected to a release treatment and/or an anti-pollution treatment with a silicone, fluoride, long-chain alkyl, or fatty acid amide release agent, a silica powder or the like, so that a back surface treatment layer (a release treatment layer and/or an anti-pollution treatment layer) may be provided on the back surface of the pressure-sensitive adhesive sheet. In particular, the pressure-sensitive adhesive sheet of the invention preferably has a structure of pressure-sensitive adhesive layer/support/back surface treatment layer.

In addition, the pressure-sensitive adhesive sheet of the invention more preferably has undergone an antistatic treatment. Such an antistatic treatment may be performed using any common antistatic treatment method such as a method of providing an antistatic layer on the back surface of the support (the surface opposite to the pressure-sensitive adhesive layer side) or a method of kneading a kneading-type antistatic agent into the support.

Examples of the method of providing an antistatic layer include a method of applying an antistatic agent, an antistatic resin composed of an antistatic agent and a resin component, a conductive resin composition containing a conductive material and a resin component, or a conductive polymer; and a method of vapor-depositing a conductive material or plating the object with a conductive material.

Examples of the antistatic agent include cationic antistatic agents such as quaternary ammonium salts, pyridinium salts, and others having a cationic functional group (such as a primary, secondary, or tertiary amino group); anionic antistatic agents such as sulfonates, sulfuric ester salts, phosphonates, phosphoric ester salts, and others having an anionic functional group; amphoteric antistatic agents such as alkylbetaine and derivatives thereof, imidazoline and derivatives thereof, and alanine and derivatives thereof; nonionic antistatic agents such as aminoalcohol and derivatives thereof, glycerin and derivatives thereof, and polyethylene glycol and derivatives thereof; and ion-conducting polymers obtained by polymerization or copolymerization of ion-conducting group-containing monomers such as the cationic, anionic, or amphoteric antistatic agents.

Specific examples of the cationic antistatic agents include alkyltrimethylammonium salts, acyloylamidopropyltrimethylammonium methosulfate, alkylbenzylmethylammonium salts, acylcholine chloride, quaternary ammonium group-containing (meth)acrylate copolymers such as polydimethylaminoethyl methacrylate, quaternary ammonium group-containing styrene copolymers such as polyvinylbenzyltrimethylammonium chloride, and quaternary ammonium group-containing diallylamine copolymers such as polydiallyldimethylammonium chloride. Examples of the anionic antistatic agents include alkylsulfonate salts, alkylbenzene sulfonate salts, alkylsulfate ester salts, alkylethoxysulfate ester salts, alkylphosphate ester salts, and sulfonic acid group-containing styrene copolymers. Examples of the amphoteric antistatic agents include alkylbetaine, alkylimidazolium betaine, and carbobetaine graft copolymers. Examples of the nonionic antistatic agents include fatty acid alkylolamide, di-(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer composed of polyether, polyester, and polyamide, and methoxypolyethylene glycol (meth)acrylate.

Examples of the conductive polymers include polyaniline, polypyrrole, and polythiophene.

Examples of the conductive materials include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof.

General-purpose resin such as polyester resin, acrylic resin, polyvinyl resin, urethane resin, melamine resin, or epoxy resin may be used as the resin component. When the antistatic agent is a polymer-type antistatic agent, the antistatic resin does not need to contain the resin component. The antistatic resin may also contain, as a crosslinking agent, a methylolated or alkylolated melamine, urea, glyoxal, or acrylamide compound, an epoxy compound, or an isocyanate compound.

The antistatic layer may be formed by a coating method including diluting the antistatic resin, the conductive polymer, or the conductive resin composition with an organic solvent, water or any other solvent or dispersion medium, then applying the resulting coating liquid to a support (substrate), and drying the coating. Examples of the organic solvent include methyl ethyl ketone, acetone, ethyl acetate, tetrahydrofuran, dioxane, cyclohexanone, n-hexane, toluene, xylene, methanol, ethanol, n-propanol, and isopropanol. These may be used singly or in combination of two or more. The method of application may be performed using a known coating technique, examples of which include roll coating, gravure coating, reverse coating, roll brush coating, spray coating, air knife coating, impregnation, and curtain coating.

The antistatic layer formed by the coating (an antistatic resin layer, a conductive polymer layer, or a conductive resin composition layer) preferably has a thickness of 0.001 to 5 μm, more preferably 0.005 to 1 μm.

Methods for vapor-deposition of the conductive material and methods for plating with the conductive material include vacuum deposition, sputtering, ion plating, chemical vapor deposition, spray pyrolysis, chemical plating, and electroplating.

The antistatic layer (conductive material layer) formed by the vapor deposition or plating preferably has a thickness of 20 to 10,000 Å (0.002 to 1 μm), more preferably 50 to 5,000 Å (0.005 to 0.5 μm).

Any of the above antistatic agents may be appropriately used as the kneading-type antistatic agent. The content of the kneading-type antistatic agent is preferably 20% by weight or less, more preferably 0.05 to 10% by weight, based on the total weight of the support (substrate) (100% by weight). The kneading method may be any method capable of uniformly mixing the kneading-type antistatic agent into, for example, a resin for use in the plastic substrate. Examples generally include methods using a heating roll, a Banbury mixer, a pressure kneader, a biaxial kneading machine, etc.

The water-dispersible acrylic pressure-sensitive adhesive composition of the invention can form a removable pressure-sensitive adhesive layer having a good level of antistatic properties, adhesion, and removability (easy peelability), and is suitable for use in forming a pressure-sensitive adhesive layer used for removable applications (for removing). Specifically, the pressure-sensitive adhesive sheet having the pressure-sensitive adhesive layer formed using the water-dispersible acrylic pressure-sensitive adhesive composition of the invention is preferably used for removable applications (e.g., masking tapes such as masking tapes for building curing, masking tapes for automobile coating, masking tapes for electronic components (such as lead frames and printed boards), and masking tapes for sandblasting; surface protecting films such as surface protecting films for aluminum sashes, surface protecting films for optical plastics, surface protecting films for optical glass products, surface protecting films for automobile protection, and surface protecting films for metal plates; pressure-sensitive adhesive tapes for use in semiconductor and electronic component processes, such as back grinding tapes, pellicle fixing tapes, dicing tapes, lead frame fixing tapes, cleaning tapes, dust removing tapes, carrier tapes, and cover tapes; tapes for packing electronic devices or electronic components; tapes for temporary bonding during transportation; binding tapes; and labels).

The pressure-sensitive adhesive layer and the pressure-sensitive adhesive sheet formed using the water-dispersible acrylic pressure-sensitive adhesive composition of the invention are excellent in appearance properties with decreased appearance defects such as dents. When bonded to an adherend, the pressure-sensitive adhesive layer and the pressure-sensitive adhesive sheet do not cause white staining on the adherend and are excellent in less-staining properties. Accordingly, the pressure-sensitive adhesive sheet of the invention is advantageously used in surface protection applications (surface protecting films for optical members) which are required to have particularly excellent appearance properties and less-staining properties, for optical members (such as optical plastics, optical glass products, and optical films) such as polarizing plates, retardation plates, anti-reflection plates, wavelength plates, optical compensation films, and brightness enhancement films for constituting panels for liquid crystal displays, organic electroluminescence (organic EL) displays, field emission displays, etc. It will be understood that such applications are non-limiting and that there are other applications such as surface protection and breakage prevention during the manufacture of fine-processed products such as semiconductors, circuits, a variety of printed boards, a variety of masks, and lead frames, removal of foreign bodies and the like, and masking.

### EXAMPLES

Hereinafter, the invention will be more specifically described with reference to examples, which however are not intended to limit the invention. In the description below, “parts” and “%” are by weight unless otherwise specified. As for the evaluation, divided into first, second and third invention group shown below, respectively, and evaluated.

### First Invention Group

### Example 1-1

### Preparation of Acrylic Emulsion Polymer

A vessel was charged with 90 parts by weight of water, and 94 parts by weight of 2-ethylhexyl acrylate (2EHA), 2 parts by weight of methyl methacrylate (MMA), 4 parts by weight of acrylic acid (AA), and 6 parts by weight of a nonionic-anionic reactive emulsifier (AQUALON HS-10 (trade name) manufactured by DAI-ICHI KOGYO SEIYAKU CO., LTD.) as shown in Table 1 and thereafter, the materials were stirred and mixed by a homomixer to form a monomer emulsion. A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight of the monomer emulsion and the mixture was subjected to emulsion polymerization at 75° C. for 1 hour with stirring. Subsequently, after 0.07 parts by weight of a polymerization initiator (ammonium persulfate) was further added, all the remaining part (90% by weight part) of the monomer emulsion was added over 3 hours with stirring, and the mixture was then subjected to reaction at 75° C. for 3 hours.

Subsequently, after the reaction mixture was cooled to 30° C., 10% by weight ammonia water was added to adjust its pH to 8, so that an aqueous dispersion of an acrylic emulsion polymer was obtained.

### (Preparation of Water-Dispersible Acrylic Pressure-Sensitive Adhesive Composition)

Based on 100 parts by weight (solid basis) of the acrylic emulsion polymer, 2 parts by weight of an ionic liquid [CIL-313, N-butyl-3-methylpyridinium trifluoromethanesulfonate (water-soluble ionic liquid) manufactured by Japan Carlit Co., Ltd.] and 3 parts by weight of an epoxy crosslinking agent [TETRAD-C (trade name) manufactured by MITSUBISHI GAS CHEMICAL COMPANY, INC., 1,3-bis(N,N-diglycidylaminomethyl)cyclohexane, epoxy equivalent: 110, number of functional groups: 4] as a non-water-soluble crosslinking agent were stirred and mixed to the aqueous dispersion of the acrylic emulsion polymer under the stirring conditions of 23° C., 300 rpm, and 10 minutes using a stirrer and thereafter filtered by a filter [Compact cartridge filter MCP-1-C10S (trade name) manufactured by Toyo Roshi Kaisha, Ltd.] to prepare a water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the obtained water-dispersible acrylic pressure-sensitive adhesive composition was applied (coated) onto the corona-treated surface of a PET film (E7415 (trade name) manufactured by TOYOBO CO., LTD., thickness: 38 μm) so that a 15-μm-thick coating would be formed after drying, and subsequently, the coated film was dried at 120° C. for 2 minutes in a hot air circulating oven and then aged at 50° C. for 3 days to give a pressure-sensitive adhesive sheet.

### Examples 1-2 to 1-8, and Comparative Examples 1-1 to 1-6

Monomer emulsions were prepared as in Example 1-1, except that the types of the raw material monomers and emulsifiers, the added amounts, etc., were changed as shown in Tables 1 and 2. Using the monomer emulsions, water-dispersible acrylic pressure-sensitive adhesive compositions and pressure-sensitive adhesive sheets were obtained as in Example 1-1. The weight average molecular weight (Mw) of solvent-insoluble components and solvent-soluble components in the acrylic emulsion polymers obtained in the examples and comparative examples is as shown in Tables 1 and 2.

### [Evaluations]

The water-dispersible acrylic pressure-sensitive adhesive compositions and the pressure-sensitive adhesive sheets obtained in the examples and the comparative examples were evaluated by the measurement method or the evaluation method described below. Tables 1 and 2 show the results of the evaluation.

(1) Breaking Elongation of Acrylic Pressure-Sensitive Adhesive Coating after Crosslinking (Production of Acrylic Pressure-Sensitive Adhesive Coating after Crosslinking)

A PET film (MRF38 manufactured by Mitsubishi Plastics, Inc.) with its surface treated with silicone was provided and each water-dispersible acrylic pressure-sensitive adhesive composition obtained in the examples and the comparative examples was applied onto the silicone-treated surface of the PET film so that a 50-μm-thick coating could be formed after drying. Subsequently, the coated film was dried at 120° C. for 2 minutes in a hot air circulating oven and then aged at 50° C. for 3 days, so that a crosslinked coating (acrylic pressure-sensitive adhesive coating after crosslinking) was obtained.

### (Measurement of Breaking Elongation)

The crosslinked coating (crosslinked acrylic pressure-sensitive adhesive coating) was then rolled to produce a cylindrical sample (50 mm in length, 1 mm² in cross-sectional area (bottom area)).

Using a tension tester, the measurement was performed in an environment at 23° C. and 50% RH. The chuck was so set that the initial measured length (initial chuck distance) could be 10 mm and each sample was subjected to a tension test under the condition of a tension speed of 50 mm/minute to measure the elongation at the breaking point (breaking elongation or elongation at breaking point).

In the tension test, the breaking elongation (elongation at breaking point) corresponds to the elongation at the time when the test piece (the cylindrical sample of the crosslinked coating) breaks, and is calculated from the following formula.

Breaking elongation (elongation at breaking point) (%)=[{(length of test piece at breaking (the chuck distance at breaking))−(initial length (10 mm))}/(initial length (10 mm))]×100

(2) Solvent-Insoluble Components of Acrylic Pressure-Sensitive Adhesive Coating after Crosslinking

A crosslinked coating (acrylic pressure-sensitive adhesive coating after crosslinking) was produced as in the above-mentioned method (1).

Then, the solvent-insoluble component content in the crosslinked coating was measured according to the above-mentioned “Method for measuring solvent-insoluble component content.”

About 0.1 g of the crosslinked coating (acrylic pressure-sensitive adhesive coating after crosslinking) was sampled and then wrapped in a porous tetrafluoroethylene sheet (NTF1122 (trade name) manufactured by NITTO DENKO CORPORATION) with an average pore size of 0.2 μm. The sheet was then tied with a kite string and the weight of the resulting product was measured, which was defined as the weight before immersion. The weight before immersion is the total amount of the crosslinked coating (sampled as mentioned above), the tetrafluoroethylene sheet, and the kite string. The total amount of the tetrafluoroethylene sheet and the kite string was also measured, which was defined as the wrapping weight.

The crosslinked coating wrapped in the tetrafluoroethylene sheet and tied with the kite string (referred to as the “sample”) was then placed in a 50 ml vessel filled with ethyl acetate and allowed to stand at 23° C. for 7 days. Subsequently, the sample was taken out of the vessel (after the treatment with ethyl acetate) and transferred into an aluminum cup, and after the sample was dried in a dryer at 130° C. for 2 hours so that the ethyl acetate was removed, the weight of the sample was measured, which was defined as the weight after immersion. The solvent-insoluble component content was calculated from the following formula.

Solvent-insoluble component content (% by weight)={(d−e)/(f−e)}×100,

wherein d is the weight after immersion, e is the wrapping weight, and f is the weight before immersion.

### (3) Peeling Electrification Voltage

The prepared pressure-sensitive adhesive sheet was cut into a piece with a size of 70 mm in width and 130 mm in length, and the separator was peeled off. Thereafter, using a hand roller, the piece was pressure-bonded to the surface of a polarizing plate (SEG1425DU (trade name) manufactured by NITTO DENKO CORPORATION) bonded to an acrylic plate (ACRYLITE manufactured by Mitsubishi Rayon Co., Ltd., 1 mm thick, 70 mm wide, and 100 mm long), which had been subjected to static elimination in advance, in such a manner that one end of the piece was protruded by 30 mm out of the plate. Subsequently, the resulting sample was allowed to stand in an environment at 23° C. and 24±2% RH for a day and then set at a predetermined location as shown in FIG. 1. The one end protruded by 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 24±2% RH.

Additionally, the pressure-sensitive adhesive sheet of the invention preferably has a peeling electrification voltage (absolute value) of 1.0 kV or less, more preferably 0.8 kV or less. If the peeling electrification voltage exceeds 1.0 kV, adsorption of dust can easily occur during the peeling off of the pressure-sensitive adhesive sheet, and it is not preferred.

### (4) Ability to Prevent Increase in Peel Strength (Adhesive Strength) (Initial Peel Strength)

The prepared pressure-sensitive adhesive sheet was cut into a piece with a size of 25 mm in width and 100 mm in length, and the separator was peeled off. Thereafter, using a laminator (Compact Laminator manufactured by TESTER SANGYO CO., LTD.), the resulting piece was then laminated onto a polarizing plate (SEG1425DU manufactured by NITTO DENKO CORPORATION, width: 70 mm, length: 100 mm) under the conditions of 0.25 MPa and 0.3 m/minute to form an evaluation sample. After the lamination, the sample was allowed to stand in an environment at 23° C. and 50% RH for 30 minutes and then subjected to measurement of peel strength (adhesive strength) (N/25 mm) at a peel angle of 180° and a peeling rate of 10 m/min using a universal tensile tester. The measured peel strength was defined as the “initial peel strength.” The measurement was performed in an environment at 23° C. and 50% RH.

Additionally, the pressure-sensitive adhesive sheet of the invention preferably has an initial peel strength of 0.1 to 1.5 N/25 mm, more preferably 0.2 to 1.2 N/25 mm. The pressure-sensitive adhesive sheet with a peel strength of 1.5 N/25 mm or less is preferable in that the pressure-sensitive adhesive sheet can be easily peeled off to make productivity or handleability higher in the process of manufacturing a polarizing plate or a liquid crystal display device. The pressure-sensitive adhesive sheet with a peel strength of 0.1 N/25 mm or more is preferable in that the pressure-sensitive adhesive sheet can be prevented from lifting or peeling in the manufacturing processes and can sufficiently function as a surface protecting pressure-sensitive adhesive sheet.

(Peel Strength after Bonding and Storing at 40° C. For 1 Week (Peel Strength Over Time))

The sample obtained by laminating the pressure-sensitive adhesive sheet and the polarizing plate was stored in an environment at 40° C. for 1 week and then allowed to stand in an environment at 23° C. and 50% RH for 2 hours. Thereafter, the sample was subjected to a 180° peel test at a peeling rate of 10 m/min to measure the peel strength (adhesive strength) (N/25 mm) of the pressure-sensitive adhesive sheet for the polarizing plate and it was defined as the “peel strength over time.”

If the difference between the peel strength over time and the initial peel strength: [(the peel strength over time)−(the initial peel strength)] is less than 0.5 N/25 mm, the pressure-sensitive adhesive sheet can be judged to be superior in the ability to prevent an increase in peel strength (adhesive strength). The difference between the peel strength over time and the initial peel strength: [(the peel strength over time)−(the initial peel strength)] of the pressure-sensitive adhesive sheet of the invention is preferably less than 0.5 N/25 mm and more preferably 0.0 to 0.2 N/25 mm. If the difference is 0.5 N/25 mm or more, the ability to prevent an increase in peel strength (adhesive strength) may be poor, so that the workability of removal of the pressure-sensitive adhesive sheet may degrade in some cases.

### (5) Less-Staining Properties (White Staining) [Humidifying Test]

Using a laminator (Compact Laminator manufactured by TESTER SANGYO CO., LTD.), the pressure-sensitive adhesive sheet (sample size: 25 mm wide×100 mm long) obtained in the examples and the comparative examples was laminated onto a polarizing plate (SEG1425DU (trade name) manufactured by NITTO DENKO CORPORATION, size: 70 mm wide×120 mm long) under the conditions of 0.25 MPa and 0.3 m/min.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours and the surface of the polarizing plate was then visually observed and evaluated for less-staining properties according to the criteria shown below. If white staining occurs on the polarizing plate as the adherend under the humid conditions (high-humidity conditions) after the bonding and peeling off of the pressure-sensitive adhesive sheet, the less-staining properties of the pressure-sensitive adhesive sheet can be judged to be not enough for use as a surface protecting film for optical members.

Good level of less-staining properties (∘): No change was found in the part where the pressure-sensitive adhesive sheet had been bonded and in the part where it had not been bonded.

Slightly poor level of less-staining properties (Δ): White staining was slightly observed in the part where the pressure-sensitive adhesive sheet had been bonded.

Poor level of less-staining properties (x): White staining was clearly observed in the part where the pressure-sensitive adhesive sheet had been bonded.

### (6) Appearance (Presence or Absence of Dents)

In the pressure-sensitive adhesive sheet obtained in each of the examples and the comparative examples, the state of the pressure-sensitive adhesive layer surface was visually observed. How many defects (dents) were present in an observed area of 10 cm long and 10 cm wide was measured and evaluated according to the criteria shown below. The number of defects was 0 to 100: Good appearance (∘)

The number of defects was 101 or more: Poor appearance (x)

TABLE 1

| | | | EXAMPLE | | | | | | | |
|---|---|---|---|---|---|---|---|---|---|---|
| CONTENTS AND EVALUATION RESULTS | | | 1-1 | 1-2 | 1-3 | 1-4 | 1-5 | 1-6 | 1-7 | 1-8 |
| ACRYLIC | MONOMER | 2EHA | 94 | 92 | 88 | 92 | 92 | 92 | 92 | 92 |
| EMULSION | COMPONENT | MMA | 2 | 4 | 8 | | | 4 | 4 | 4 |
| POLYMER | | Vac | | | | 4 | | | | |
| (PARTS BY | | DEAA | | | | | 4 | | | |
| WEIGHT) | | AA | 4 | 4 | 4 | 4 | 4 | 4 | 4 | 4 |
| | REACTIVE | HS10 | 6 | 3 | 3 | | | 3 | 3 | 3 |
| | EMULSIFIER | SE-10N | | | | 4.5 | 3 | | | |
| | SOLVENT-INSOLUBLE COMPONENT | | 81 | 85 | 86 | 82 | 81 | 85 | 85 | 85 |
| | CONTENT (%) | | | | | | | | | |
| | WEIGHT AVERAGE MOLECULAR | | 8 | 10 | 10 | 7 | 8 | 7 | 7 | 7 |
| | WEIGHT [×10⁴] OF | | | | | | | | | |
| | SOLVENT-SOLUBLE COMPONENTS | | | | | | | | | |
| PRESSURE-SENSITIVE | ACRYLIC EMULSION POLYMER | | 100 | 100 | 100 | 100 | 100 | 100 | 100 | 100 |
| ADHESIVE | WATER-INSOLUBLE | T/C | 3 | 3 | 3 | 3 | 4 | 2 | 2.5 | |
| COMPOSITION | CROSSLINKING | T/X | | | | | | | | 3 |
| (PARTS BY | AGENT | | | | | | | | | |
| WEIGHT) | CROSSLINKING | CC-36 | | | | | | | | |
| | CATALYST | | | | | | | | | |
| | [NUMBER OF MOLES OF EPOXY | | 0.5 | 0.5 | 0.5 | 0.5 | 0.7 | 0.3 | 0.4 | 0.5 |
| | GROUP (GLYCIDYLAMINO | | | | | | | | | |
| | GROUP)]/(NUMBER OF MOLES OF | | | | | | | | | |
| | CARBOXYL GROUP) (MOLAR | | | | | | | | | |
| | RATIO) | | | | | | | | | |
| | WATER-SOLUBLE | CIL-313 | 2 | 1 | | | | 1 | | |
| | IONIC LIQUID | EtMePy-EF21 | | | 0.5 | 0.5 | 3 | | | 0.5 |
| | | EMI-EF31 | | | | | | | 1 | |
| | WATER-INSOLUBLE | IL-130 | | | | | | | | |
| | IONIC LIQUID | | | | | | | | | |
| | POLYETHER | 25R-1 | | | | | | 0.5 | | 0.5 |
| | ANTIFOAMER | 17R-4 | | | | | | | 1 | |
| | SOLVENT-INSOLUBLE COMPONENT | | 97 | 97 | 98 | 97 | 97 | 96 | 97 | 97 |
| | CONTENT AFTER CROSSLINKING | | | | | | | | | |
| | (COATING) (%) | | | | | | | | | |
| | BREAKING ELONGATION | | 105 | 103 | 91 | 112 | 104 | 153 | 107 | 98 |
| | (COATING) (%) | | | | | | | | | |
| EVALUATION | PEELING | ABSOLUTE | 0.1 | 0.1 | 0.0 | 0.0 | 0.0 | 0.1 | 0.0 | 0.0 |
| RESULTS | ELECTRIFICATION | VALUE | | | | | | | | |
| | VOLTAGE [kV] | PEELING | | | | | | | | |
| | | RATE: 10 m/min | | | | | | | | |
| | ABILITY TO | INITIAL | 0.6 | 0.5 | 0.5 | 0.6 | 0.4 | 0.5 | 0.5 | 0.5 |
| | PREVENT INCREASE | ADHESIVE | | | | | | | | |
| | IN PEEL STRENGTH | STRENGTH | | | | | | | | |
| | (ADHESIVE | PEELING | | | | | | | | |
| | STRENGTH) | RATE: 10 m/min | | | | | | | | |
| | [N/25 mm] | PEEL | 0.5 | 0.5 | 0.4 | 0.6 | 0.4 | 0.7 | 0.5 | 0.5 |
| | | STRENGTH | | | | | | | | |
| | | OVER TIME | | | | | | | | |
| | | PEELING | | | | | | | | |
| | | RATE: 10 m/min | | | | | | | | |

| | | | | | | | | |
|---|---|---|---|---|---|---|---|---|
| LESS-STAINING PROPERTIES | ◯ | ◯ | ◯ | ◯ | ◯ | ◯ | ◯ | ◯ |
| APPEARANCE | ◯ | ◯ | ◯ | ◯ | ◯ | ◯ | ◯ | ◯ |

TABLE 2

| | | | COMPARATIVE EXAMPLE | | | | | |
|---|---|---|---|---|---|---|---|---|
| CONTENTS AND EVALUATION RESULTS | | | 1-1 | 1-2 | 1-3 | 1-4 | 1-5 | 1-6 |
| ACRYLIC | MONOMER | 2EHA | 96 | 96 | 96 | 92 | 96 | 99.6 |
| EMULSION | COMPONENT | MMA | | | | 4 | | |
| POLYMER | | Vac | | | | | | |
| (PARTS BY | | DEAA | | | | | | |
| WEIGHT) | | AA | 4 | 4 | 4 | 4 | 4 | 0.4 |
| | REACTIVE | HS10 | 3 | 3 | 3 | | 3 | 3 |
| | EMULSIFIER | SE-10N | | | | 6 | | |
| | SOLVENT-INSOLUBLE COMPONENT | | 83 | 83 | 83 | 73 | 83 | 78 |
| | CONTENT (%) | | | | | | | |
| | WEIGHT AVERAGE MOLECULAR | | 8 | 8 | 8 | 24 | 8 | 16 |
| | WEIGHT [×10⁴] OF | | | | | | | |
| | SOLVENT-SOLUBLE COMPONENTS | | | | | | | |
| PRESSURE-SENSITIVE | ACRYLIC EMULSION POLYMER | | 100 | 100 | 100 | 100 | 100 | 100 |
| ADHESIVE | WATER-INSOLUBLE | T/C | 3 | 3 | 1 | 3 | 3 | 0.3 |
| COMPOSITION | CROSSLINKING | T/X | | | | | | |
| (PARTS BY | AGENT | | | | | | | |
| WEIGHT) | CROSSLINKING | CC-36 | | | 1.5 | | | |
| | CATALYST | | | | | | | |
| | [NUMBER OF MOLES OF EPOXY GROUP | | 0.5 | 0.5 | 0.2 | 0.5 | 0.5 | 0.5 |
| | (GLYCIDYLAMINO | | | | | | | |
| | GROUP)]/(NUMBER OF MOLES OF | | | | | | | |
| | CARBOXYL GROUP) (MOLAR RATIO) | | | | | | | |
| | WATER-SOLUBLE | CIL-313 | | | | | 1 | |
| | IONIC LIQUID | EtMePy-EF21 | | | | | | |
| | | EMI-EF31 | | | | | | |
| | WATER-INSOLUBLE | IL-130 | | 5 | | | | |
| | IONIC LIQUID | | | | | | | |
| | POLYETHER | 25R-1 | | | | | | |
| | ANTIFOAMER | 17R-4 | | | | | | |
| | SOLVENT-INSOLUBLE COMPONENT | | 97 | 95 | 93 | 88 | 97 | 82 |
| | CONTENT AFTER CROSSLINKING | | | | | | | |
| | (COATING) (%) | | | | | | | |
| | BREAKING ELONGATION (COATING) | | 103 | 123 | 218 | 134 | 103 | 162 |
| | (%) | | | | | | | |
| EVALUATION | PEELING | ABSOLUTE VALUE | 1.5 | 0.0 | 1.5 | 1.5 | 0.0 | 1.5 |
| RESULTS | ELECTRIFICATION | PEELING RATE: | | | | | | |
| | VOLTAGE [kV] | 10 m/min | | | | | | |
| | ABILITY TO | INITIAL | 0.5 | 0.4 | 1.6 | 0.6 | 0.5 | 2.8 |
| | PREVENT | ADHESIVE | | | | | | |
| | INCREASE IN | STRENGTH | | | | | | |
| | PEEL STRENGTH | PEELING RATE: | | | | | | |
| | (ADHESIVE | 10 m/min | | | | | | |
| | STRENGTH) | PEEL STRENGTH | 0.5 | 0.4 | 4.9 | 0.8 | 0.5 | 5.1 |
| | [N/25 mm] | OVER TIME | | | | | | |
| | | PEELING RATE: | | | | | | |
| | | 10 m/min | | | | | | |

| | | | | | | |
|---|---|---|---|---|---|---|
| LESS-STAINING PROPERTIES | ◯ | X | X | Δ | ◯ | X |
| APPEARANCE | X | X | X | ◯ | X | X |

In Tables 1 and 2, the mixing amounts and added amounts of the polymerization initiators, emulsifiers, and crosslinking catalysts were actual added amounts (added amounts of commercial products). The amount of the acrylic emulsion polymer was the weight of the solid matter.

In Table 1, the weight of the solid is shown with respect to each component. The abbreviations used in Table 1 are as follows.

2EHA: 2-ethylhexyl acrylate (acrylic acid 2-ethylhexyl ester)

MMA: methyl methacrylate (methacrylic acid methyl ester)

Vac: vinyl acetate

DEAA: diethylacrylamide

AA: acrylic acid

HS10: AQUALON HS-10 (trade name) manufactured by DAI-ICHI KOGYO SEIYAKU CO., LTD. (nonionic-anionic reactive emulsifier)

SE-10N: ADEKA REASOAP SE-10N (trade name) manufactured by ADEKA CORPORATION (nonionic-anionic reactive emulsifier)

T/C (TETRAD-C): TETRAD-C (trade name) manufactured by MITSUBISHI GAS CHEMICAL COMPANY, INC. (1,3-bis(N,N-diglycidylaminomethyl)cyclohexane, epoxy equivalent: 110, number of functional groups: 4)

T/X (TETRAD-X): TETRAD-X (trade name) manufactured by MITSUBISHI GAS CHEMICAL COMPANY, INC. (1,3-bis(N,N-diglycidylaminomethyl)benzene, epoxy equivalent: 100, number of functional groups: 4)

CC-36: ADEKA COL CC-36 (trade name) manufactured by ADEKA CORPORATION (polyether quaternary ammonium chloride)

CIL-313: N-butyl-3-methylpyridinium trifluoromethanesulfonate (water-soluble) manufactured by Japan Carlit Co., Ltd.

EtMePy-EF21: N-ethyl-3-methylpyridinium perfluoroethanesulfonate (water-soluble) manufactured by Mitsubishi Materials Electronic Chemicals Co., Ltd.

EMI-EF31: N-ethyl-3-methylimidazolium perfluoropropanesulfonate (water-soluble) manufactured by Mitsubishi Materials Electronic Chemicals Co., Ltd.

IL-130: 1-methyl-1-propylpiperidinium bis(fluorosulfonyl)imide (non-water-soluble) manufactured by DAI-ICHI KOGYO SEIYAKU CO., LTD.

25R-1: ADEKA PLURONIC 25R-1 (trade name) manufactured by ADEKA CORPORATION (PO content: 90% by weight, number average molecular weight: 2,800, polyether antifoamer)

17R-4: ADEKA PLURONIC 17R-4 (trade name) manufactured by ADEKA CORPORATION (PO content: 60% by weight, number average molecular weight: 2,500, polyether antifoamer)

From the results in Table 1, it was found that pressure-sensitive adhesive sheets superior in antistatic properties, adhesive properties, and ability to prevent an increase in peel strength (adhesive strength) over time, and also superior in appearance properties and less-staining properties can be obtained in the examples.

On the other hand, from the results in Table 2, it was found that since no specific monomer (methyl methacrylate or the like) and no water-soluble (hydrophilic) ionic liquid were added in Comparative Example 1-1, the resulting pressure-sensitive adhesive sheet had poor antistatic properties and appearance properties. Further, it was found that since no specific monomer (methyl methacrylate or the like) was added and a hydrophobic ionic liquid was added in Comparative Example 1-2, the resulting pressure-sensitive adhesive sheet had poor less-staining properties and appearance properties. In Comparative Example 1-3, since no specific monomer (methyl methacrylate or the like) and no water-soluble (hydrophilic) ionic liquid were added and further a quaternary ammonium salt, a crosslinking catalyst, was added, the resulting pressure-sensitive adhesive sheet had poor antistatic properties, less-staining properties, and appearance properties. Especially, since the crosslinking catalyst was added, the pressure-sensitive adhesive sheet was poor in the less-staining properties. In Comparative Example 1-4, since no water-soluble (hydrophilic) ionic liquid was added, the resulting pressure-sensitive adhesive sheet had poor antistatic properties. Further, since the weight average molecular weight of the solvent-soluble components in the acrylic emulsion copolymer was large, and the less-staining properties were slightly inferior. Further, in Comparative Example 1-5, since no specific monomer (methyl methacrylate or the like) was added, the resulting pressure-sensitive adhesive sheet had poor appearance properties. In Comparative Example 1-6, since no specific monomer (methyl methacrylate or the like) was added and the added amount of the (meth)acrylic acid alkyl ester monomer exceeded the desired range, the resulting pressure-sensitive adhesive sheet had poor adhesive properties, ability to prevent an increase in peel strength, appearance properties, and less-staining properties. Further, since no water-soluble (hydrophilic) ionic liquid was added, the resulting pressure-sensitive adhesive sheet had poor antistatic properties.

### Second Invention Group

### Example 2-1

### Preparation of Acrylic Emulsion Polymer

A vessel was charged with 90 parts by weight of water, and 94 parts by weight of 2-ethylhexyl acrylate (2EHA), 2 parts by weight of methyl methacrylate (MMA), 4 parts by weight of acrylic acid (AA), and 6 parts by weight of a nonionic-anionic reactive emulsifier (AQUALON HS-10 (trade name) manufactured by DAI-ICHI KOGYO SEIYAKU CO., LTD.) as shown in Table 3 and thereafter, the materials were stirred and mixed by a homomixer to form a monomer emulsion. A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight of the monomer emulsion and the mixture was subjected to emulsion polymerization at 75° C. for 1 hour with stirring. Subsequently, after 0.07 parts by weight of a polymerization initiator (ammonium persulfate) was further added, all the remaining part (90% by weight part) of the monomer emulsion was added over 3 hours with stirring, and the mixture was then subjected to reaction at 75° C. for 3 hours. Subsequently, after the reaction mixture was cooled to 30° C., 10% by weight ammonia water was added to adjust its pH to 8, so that an aqueous dispersion of an acrylic emulsion polymer was obtained.

### (Preparation of Water-Dispersible Acrylic Pressure-Sensitive Adhesive Composition)

Based on 100 parts by weight (solid basis) of the acrylic emulsion polymer, 0.5 parts by weight of an ionic liquid [IL-110, 1-ethyl-3-methylimidazolium bis(fluorosulfonyl)imide (non-water-soluble ionic liquid) manufactured by DAI-ICHI KOGYO SEIYAKU CO., LTD.] and 3 parts by weight of an epoxy crosslinking agent [TETRAD-C (trade name), 1,3-bis(N,N-diglycidylaminomethyl)cyclohexane, epoxy equivalent: 110, number of functional groups: 4, manufactured by MITSUBISHI GAS CHEMICAL COMPANY, INC.] as a non-water-soluble crosslinking agent were stirred and mixed to the aqueous dispersion of the acrylic emulsion polymer under the stirring conditions of 23° C., 300 rpm, and 10 minutes to prepare a water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the obtained water-dispersible acrylic pressure-sensitive adhesive composition was applied (coated) onto the corona-treated surface of a PET film (E7415 (trade name) manufactured by TOYOBO CO., LTD., thickness: 38 μm) so that a 15-μm-thick coating would be formed after drying, and subsequently, the coated film was dried at 120° C. for 2 minutes in a hot air circulating oven and then aged at 50° C. for 3 days to give a pressure-sensitive adhesive sheet.

### Examples 2-2 to 2-8 and Comparative Examples 2-1 to 2-5

Monomer emulsions were prepared as in Example 2-1, except that the types of the raw material monomers and emulsifiers, the added amounts, etc., were changed as shown in Tables 3 and 4. Using the monomer emulsions, water-dispersible acrylic pressure-sensitive adhesive compositions and pressure-sensitive adhesive sheets were obtained as in Example 2-1. The weight average molecular weight (Mw) of solvent-insoluble components and solvent-soluble components in the acrylic emulsion polymers obtained in examples and comparative examples is as shown in Tables 3 and 4.

### [Evaluations]

The water-dispersible acrylic pressure-sensitive adhesive compositions and the pressure-sensitive adhesive sheets obtained in the examples and the comparative examples were evaluated by the measurement method or the evaluation method described below. Tables 3 and 4 show the results of the evaluation.

(1) Breaking Elongation of Acrylic Pressure-Sensitive Adhesive Coating after Crosslinking (Production of Acrylic Pressure-Sensitive Adhesive Coating after Crosslinking)

A PET film (MRF38 manufactured by Mitsubishi Plastics, Inc.) with its surface treated with silicone was provided and each water-dispersible acrylic pressure-sensitive adhesive composition obtained in the examples and the comparative examples was applied onto the silicone-treated surface of the PET film so that a 50-μm-thick coating could be formed after drying. Subsequently, the coated film was dried at 120° C. for 2 minutes in a hot air circulating oven and then aged at 50° C. for 3 days, so that a crosslinked coating (acrylic pressure-sensitive adhesive coating after crosslinking) was obtained.

### (Measurement of Breaking Elongation)

The crosslinked coating (crosslinked acrylic pressure-sensitive adhesive coating) was then rolled to produce a cylindrical sample (50 mm in length, 1 mm² in cross-sectional area (bottom area)).

Using a tension tester, the measurement was performed in an environment at 23° C. and 50% RH. The chuck was so set that the initial measured length (initial chuck distance) could be 10 mm and each sample was subjected to a tension test under the condition of a tension speed of 50 mm/minute to measure the elongation at the breaking point (breaking elongation or elongation at breaking point).

In the tension test, the breaking elongation (elongation at breaking point) corresponds to the elongation at the time when the test piece (the cylindrical sample of the crosslinked coating) breaks, and is calculated from the following Formula.

Breaking elongation (elongation at breaking point) (%)=[{(length of test piece at breaking (the chuck distance at breaking))−(initial length (10 mm))}/(initial length (10 mm))]×100

(2) Solvent-Insoluble Components of Acrylic Pressure-Sensitive Adhesive Coating after Crosslinking

A crosslinked coating (acrylic pressure-sensitive adhesive coating after crosslinking) was produced as in the above-mentioned method (1).

Then, the solvent-insoluble component content in the crosslinked coating was measured according to the above-mentioned “Method for measuring solvent-insoluble component content.”

About 0.1 g of the crosslinked coating (acrylic pressure-sensitive adhesive coating after crosslinking) was sampled and then wrapped in a porous tetrafluoroethylene sheet (NTF1122 (trade name) manufactured by NITTO DENKO CORPORATION) with an average pore size of 0.2 μm. The sheet was then tied with a kite string and the weight of the resulting product was measured, which was defined as the weight before immersion. The weight before immersion is the total amount of the crosslinked coating (sampled as mentioned above), the tetrafluoroethylene sheet, and the kite string. The total amount of the tetrafluoroethylene sheet and the kite string was also measured, which was defined as the wrapping weight.

The crosslinked coating wrapped in the tetrafluoroethylene sheet and tied with the kite string (referred to as the “sample”) was then placed in a 50 ml vessel filled with ethyl acetate and allowed to stand at 23° C. for 7 days. Subsequently, the sample was taken out of the vessel (after the treatment with ethyl acetate) and transferred into an aluminum cup, and after the sample was dried in a dryer at 130° C. for 2 hours so that the ethyl acetate was removed, the weight of the sample was measured, which was defined as the weight after immersion. The solvent-insoluble component content was calculated from the following formula.

Solvent-insoluble component content (% by weight)={(d−e)/(f−e)}×100,

wherein d is the weight after immersion, e is the wrapping weight, and f is the weight before immersion.

### (3) Peeling Electrification Voltage

The prepared pressure-sensitive adhesive sheet was cut into a piece with a size of 70 mm in width and 130 mm in length, and the separator was peeled off. Thereafter, using a hand roller, the piece was pressure-bonded to the surface of a polarizing plate (SEG1425DU (trade name) manufactured by NITTO DENKO CORPORATION) bonded to an acrylic plate (ACRYLITE manufactured by Mitsubishi Rayon Co., Ltd., 1 mm thick, 70 mm wide, and 100 mm long), which had been subjected to static elimination in advance, in such a manner that one end of the piece was protruded by 30 mm out of the plate. Subsequently, the resulting sample was allowed to stand in an environment at 23° C. and 24±2% RH for a day and then set at a predetermined location as shown in FIG. 1. The one end protruded by 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 24±2% RH.

Additionally, the pressure-sensitive adhesive sheet of the invention preferably has a peeling electrification voltage (absolute value) of 1.0 kV or less, more preferably 0.8 kV or less. If the peeling electrification voltage exceeds 1.0 kV, adsorption of dust can easily occur during the peeling off of the pressure-sensitive adhesive sheet, and it is not preferred.

### (4) Ability to Prevent Increase in Peel Strength (Adhesive Strength) (Initial Peel Strength)

The prepared pressure-sensitive adhesive sheet was cut into a piece with a size of 25 mm in width and 100 mm in length, and the separator was peeled off. Thereafter, using a laminator (Compact Laminator manufactured by TESTER SANGYO CO., LTD.), the resulting piece was then laminated onto a polarizing plate (SEG1425DU manufactured by NITTO DENKO CORPORATION, width: 70 mm, length: 100 mm) under the conditions of 0.25 MPa and 0.3 m/minute to form an evaluation sample. After the lamination, the sample was allowed to stand in an environment at 23° C. and 50% RH for 30 minutes and then subjected to measurement of peel strength (adhesive strength) (N/25 mm) at a peel angle of 180° and a peeling rate of 10 m/min using a universal tensile tester. The measured peel strength was defined as the “initial peel strength.” The measurement was performed in an environment at 23° C. and 50% RH.

Additionally, the pressure-sensitive adhesive sheet of the invention preferably has an initial peel strength of 0.1 to 1.5 N/25 mm, more preferably 0.2 to 1.2 N/25 mm. The pressure-sensitive adhesive sheet with a peel strength of 1.5 N/25 mm or less is preferable in that the pressure-sensitive adhesive sheet can be easily peeled off to make productivity or handleability higher in the process of manufacturing a polarizing plate or a liquid crystal display device. The pressure-sensitive adhesive sheet with a peel strength of 0.1N/25 mm or more is preferable in that the pressure-sensitive adhesive sheet can be prevented from lifting or peeling in the manufacturing processes and can sufficiently protecting function as a surface protecting pressure-sensitive adhesive sheet.

(Peel Strength after Bonding and Storing at 40° C. For 1 Week (Peel Strength Over Time))

The sample obtained by laminating the pressure-sensitive adhesive sheet and the polarizing plate was stored in an environment at 40° C. for 1 week and then allowed to stand in an environment at 23° C. and 50% RH for 2 hours. Thereafter, the sample was subjected to a 180° peel test at a peeling rate of 10 m/min to measure the peel strength (adhesive strength) (N/25 mm) of the pressure-sensitive adhesive sheet for the polarizing plate and it was defined as the “peel strength over time.”

If the difference between the peel strength over time and the initial peel strength: [(the peel strength over time)−(the initial peel strength)] is less than 0.5 N/25 mm, the pressure-sensitive adhesive sheet can be judged to be superior in the ability to prevent an increase in peel strength (adhesive strength). The difference between the peel strength over time and the initial peel strength: [(the peel strength over time)−(the initial peel strength)] of the pressure-sensitive adhesive sheet of the invention is preferably less than 0.5 N/25 mm and more preferably 0.0 to 0.2 N/25 mm. If the difference is 0.5 N/25 mm or more, the ability to prevent an increase in peel strength (adhesive strength) may be poor, so that the workability of removal of the pressure-sensitive adhesive sheet may degrade in some cases.

### (5) Less-Staining Properties (White Staining) [Humidifying Test]

Using a laminator (Compact Laminator manufactured by TESTER SANGYO CO., LTD.), the pressure-sensitive adhesive sheet (sample size: 25 mm wide×100 mm long) obtained in the examples and the comparative examples was laminated onto a polarizing plate (SEG1425DU (trade name) manufactured by NITTO DENKO CORPORATION, size: 70 mm wide×120 mm long) under the conditions of 0.25 MPa and 0.3 m/min.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours and the surface of the polarizing plate was then visually observed and evaluated for less-staining properties according to the criteria shown below. If white staining occurs on the polarizing plate as the adherend under the humid conditions (high-humidity conditions) after the bonding and peeling off of the pressure-sensitive adhesive sheet, the less-staining properties of the pressure-sensitive adhesive sheet can be judged to be not enough for use as a surface protecting film for optical members.

Good level of less-staining properties (∘): No change was found in the part where the pressure-sensitive adhesive sheet had been bonded and in the part where it had not been bonded.

Slightly poor level of less-staining properties (Δ): White staining was slightly observed in the part where the pressure-sensitive adhesive sheet had been bonded.

Poor level of less-staining properties (x): White staining was clearly observed in the part where the pressure-sensitive adhesive sheet had been bonded.

### (6) Appearance (Presence or Absence of Dents or Gel Parts)

In the pressure-sensitive adhesive sheet obtained in each of the examples and the comparative examples, the state of the pressure-sensitive adhesive layer surface was visually observed. How many defects (dents and gel parts) were present in an observed area of 10 cm long and 10 cm wide was measured and evaluated according to the criteria shown below.

The number of defects was 0 to 100: Good appearance (∘)

The number of defects was 101 or more: Poor appearance (x)

TABLE 3

| | | | EXAMPLE | | | | | | | |
|---|---|---|---|---|---|---|---|---|---|---|
| CONTENTS AND EVALUATION RESULTS | | | 2-1 | 2-2 | 2-3 | 2-4 | 2-5 | 2-6 | 2-7 | 2-8 |
| ACRYLIC | MONOMER | 2EHA | 94 | 92 | 88 | 92 | 92 | 92 | 92 | 92 |
| EMULSION | COMPONENT | MMA | 2 | 4 | 8 | | | 4 | 4 | 4 |
| POLYMER | | Vac | | | | 4 | | | | |
| (PARTS BY | | DEAA | | | | | 4 | | | |
| WEIGHT) | | AA | 4 | 4 | 4 | 4 | 4 | 4 | 4 | 4 |
| | REACTIVE | HS10 | 6 | 3 | 3 | | | 3 | 3 | 3 |
| | EMULSIFIER | SE-10N | | | | 4.5 | 3 | | | |
| | SOLVENT-INSOLUBLE COMPONENT | | 81 | 85 | 86 | 82 | 81 | 85 | 85 | 85 |
| | CONTENT (%) | | | | | | | | | |
| | WEIGHT AVERAGE MOLECULAR | | 8 | 10 | 10 | 7 | 8 | 10 | 10 | 10 |
| | WEIGHT [×10⁴] OF | | | | | | | | | |
| | SOLVENT-SOLUBLE COMPONENTS | | | | | | | | | |
| PRESSURE-SENSITIVE | ACRYLIC EMULSION POLYMER | | 100 | 100 | 100 | 100 | 100 | 100 | 100 | 100 |
| ADHESIVE | WATER-INSOLUBLE | T/C | 3 | 3 | 3 | 3 | 4 | 2 | 2.5 | |
| COMPOSITION | CROSSLINKING | T/X | | | | | | | | 3 |
| (PARTS BY | AGENT | | | | | | | | | |
| WEIGHT) | CROSSLINKING | CC-36 | | | | | | | | |
| | CATALYST | | | | | | | | | |
| | [NUMBER OF MOLES OF EPOXY | | 0.5 | 0.5 | 0.5 | 0.5 | 0.7 | 0.3 | 0.4 | 0.5 |
| | GROUP (GLYCIDYLAMINO | | | | | | | | | |
| | GROUP)]/(NUMBER OF MOLES OF | | | | | | | | | |
| | CARBOXYL GROUP) (MOLAR | | | | | | | | | |
| | RATIO) | | | | | | | | | |
| | WATER-SOLUBLE | IL-110 | 0.5 | 0.5 | 0.5 | | | 0.5 | 0.5 | |
| | IONIC LIQUID | IL-120 | | | | | 3 | | | 0.5 |
| | | IL-130 | | | | 3 | | | | |
| | POLYETHER | 25R-1 | | | | | | 0.5 | | 0.5 |
| | ANTIFOAMER | 17R-4 | | | | | | | 1 | |
| | SOLVENT-INSOLUBLE COMPONENT | | 97 | 97 | 97 | 97 | 98 | 96 | 97 | 97 |
| | CONTENT AFTER CROSSLINKING | | | | | | | | | |
| | (COATING) (%) | | | | | | | | | |
| | BREAKING ELONGATION | | 108 | 101 | 91 | 112 | 104 | 148 | 109 | 98 |
| | (COATING) (%) | | | | | | | | | |
| EVALUATION | PEELING | ABSOLUTE | 0.1 | 0.1 | 0.0 | 0.0 | 0.0 | 0.1 | 0.1 | 0.0 |
| RESULTS | ELECTRIFICATION | VALUE | | | | | | | | |
| | VOLTAGE [kV] | PEELING | | | | | | | | |
| | | RATE: 10 m/min | | | | | | | | |
| | ABILITY TO | INITIAL | 0.5 | 0.5 | 0.5 | 0.5 | 0.5 | 0.5 | 0.5 | 0.4 |
| | PREVENT INCREASE | PEEL | | | | | | | | |
| | IN PEEL STRENGTH | STRENGTH | | | | | | | | |
| | (ADHESIVE | PEELING | | | | | | | | |
| | STRENGTH) | RATE: 10 m/min | | | | | | | | |
| | (INITIAL PEEL | PEEL | 0.5 | 0.5 | 0.4 | 0.5 | 0.5 | 0.5 | 0.5 | 0.4 |
| | STRENGTH | STRENGTH | | | | | | | | |
| | [N/25 mm] | OVER TIME | | | | | | | | |
| | | PEELING | | | | | | | | |
| | | RATE: 10 m/min | | | | | | | | |

| | | | | | | | | |
|---|---|---|---|---|---|---|---|---|
| LESS-STAINING PROPERTIES | ◯ | ◯ | ◯ | ◯ | ◯ | ◯ | ◯ | ◯ |
| APPEARANCE | ◯ | ◯ | ◯ | ◯ | ◯ | ◯ | ◯ | ◯ |

TABLE 4

| | | | COMPARATIVE EXAMPLE | | | | |
|---|---|---|---|---|---|---|---|
| CONTENTS AND EVALUATION RESULTS | | | 2-1 | 2-2 | 2-3 | 2-4 | 2-5 |
| ACRYLIC | MONOMER | 2EHA | 96 | 96 | 92 | 92 | 99.6 |
| EMULSION | COMPONENT | MMA | | | 4 | 4 | |
| POLYMER | | Vac | | | | | |
| (PARTS BY | | DEAA | | | | | |
| WEIGHT) | | AA | 4 | 4 | 4 | 4 | 0.4 |
| | REACTIVE | HS10 | 3 | 3 | 3 | | 3 |
| | EMULSIFIER | SE-10N | | | | 6 | |
| | SOLVENT-INSOLUBLE COMPONENT | | 83 | 83 | 85 | 73 | 78 |
| | CONTENT (%) | | | | | | |
| | WEIGHT AVERAGE MOLECULAR WEIGHT | | 8 | 8 | 10 | 24 | 16 |
| | [×10⁴] OF SOLVENT-SOLUBLE | | | | | | |
| | COMPONENTS | | | | | | |
| PRESSURE-SENSITIVE | ACRYLIC EMULSION POLYMER | | 100 | 100 | 100 | 100 | 100 |
| ADHESIVE | WATER-INSOLUBLE | T/C | 3 | 5 | 1 | 3 | 0.3 |
| COMPOSITION | CROSSLINKING | T/X | | | | | |
| (PARTS BY | AGENT | | | | | | |
| WEIGHT) | CROSSLINKING | CC-36 | | | 1.5 | | |
| | CATALYST | | | | | | |
| | [NUMBER OF MOLES OF EPOXY GROUP | | 0.5 | 0.5 | 0.2 | 0.5 | 0.5 |
| | (GLYCIDYLAMINO GROUP)]/(NUMBER | | | | | | |
| | OF MOLES OF CARBOXYL GROUP) | | | | | | |
| | (MOLAR RATIO) | | | | | | |
| | WATER-SOLUBLE | IL-110 | | 5 | | | |
| | IONIC LIQUID | IL-120 | | | | | |
| | | IL-130 | | | | | |
| | POLYETHER | 25R-1 | | | | | |
| | ANTIFOAMER | 17R-4 | | | | | |
| | SOLVENT-INSOLUBLE COMPONENT | | 97 | 94 | 93 | 88 | 82 |
| | CONTENT AFTER CROSSLINKING | | | | | | |
| | (COATING) (%) | | | | | | |
| | BREAKING ELONGATION (COATING) | | 103 | 119 | 218 | 134 | 162 |
| | (%) | | | | | | |
| EVALUATION | PEELING | ABSOLUTE VALUE | 1.5 | 0.0 | 1.5 | 1.5 | 1.5 |
| RESULTS | ELECTRIFICATION | PEELING RATE: | | | | | |
| | VOLTAGE [kV] | 10 m/min | | | | | |
| | ABILITY TO | INITIAL PEEL | 0.5 | 0.3 | 1.1 | 0.5 | 2.8 |
| | PREVENT INCREASE | STRENGTH | | | | | |
| | IN PEEL STRENGTH | PEELING RATE: | | | | | |
| | (ADHESIVE | 10 m/min | | | | | |
| | STRENGTH) | PEEL STRENGTH | 0.5 | 0.3 | 4.6 | 0.7 | 5.1 |
| | [N/25 mm] | OVER TIME | | | | | |
| | | PEELING RATE: | | | | | |
| | | 10 m/min | | | | | |

| | | | | | |
|---|---|---|---|---|---|
| LESS-STAINING PROPERTIES | ◯ | X | X | Δ | X |
| APPEARANCE | X | X | ◯ | ◯ | X |

In Tables 3 and 4, the mixing amounts and added amounts of the polymerization initiators, emulsifiers, and crosslinking catalysts were actual added amounts (added amounts of commercial products). The amount of the acrylic emulsion polymer was the weight of the solid matter.

In Table 3, the weight of the solid is shown with respect to each component. The abbreviations used in Table 3 are as follows.

2EHA: 2-ethylhexyl acrylate (acrylic acid 2-ethylhexyl ester)

MMA: methyl methacrylate (methacrylic acid methyl ester)

Vac: vinyl acetate

DEAA: diethylacrylamide

AA: acrylic acid

HS10: AQUALON HS-10 (trade name) manufactured by DAI-ICHI KOGYO SEIYAKU CO., LTD. (nonionic-anionic reactive emulsifier)

SE-10N: ADEKA REASOAP SE-10N (trade name) manufactured by ADEKA CORPORATION (nonionic-anionic reactive emulsifier)

T/C (TETRAD-C): TETRAD-C (trade name) manufactured by MITSUBISHI GAS CHEMICAL COMPANY, INC. (1,3-bis(N,N-diglycidylaminomethyl)cyclohexane, epoxy equivalent: 110, number of functional groups: 4, non-water-soluble crosslinking agent)

T/X (TETRAD-X): TETRAD-X (trade name) manufactured by MITSUBISHI GAS CHEMICAL COMPANY, INC. (1,3-bis(N,N-diglycidylaminomethyl)benzene, epoxy equivalent: 100, number of functional groups: 4, non-water-soluble crosslinking agent)

CC-36: ADEKA COL CC-36 (trade name) manufactured by ADEKA CORPORATION (polyether quaternary ammonium chloride, Crosslinking catalyst)

IL-110: 1-ethyl-3-methylimidazolium bis(fluorosulfonyl)imide (non-water-soluble ionic liquid) manufactured by DAI-ICHI KOGYO SEIYAKU CO., LTD.

IL-120: 1-methyl-1-propylpyrrolidinium bis(fluorosulfonyl)imide (non-water-soluble ionic liquid) manufactured by DAI-ICHI KOGYO SEIYAKU CO., LTD.

IL-130: 1-methyl-1-propylpiperidinium bis(fluorosulfonyl)imide (non-water-soluble ionic liquid) manufactured by DAI-ICHI KOGYO SEIYAKU Co., Ltd.

25R-1: ADEKA PLURONIC 25R-1 (trade name) manufactured by ADEKA CORPORATION (oxypropylene group content: 90% by weight, number average molecular weight: 2,800, polyether antifoamer)

17R-4: ADEKA PLURONIC 17R-4 (trade name) manufactured by ADEKA CORPORATION (oxypropylene group content: 60% by weight, number average molecular weight: 2,500, polyether antifoamer)

From the results in Table 3, it was found that pressure-sensitive adhesive sheets superior in antistatic properties, adhesive properties, and ability to prevent an increase in peel strength (adhesive strength) over time, and also superior in appearance properties and less-staining properties can be obtained in the examples.

On the other hand, from the results in Table 4, it was found that since no specific monomer and no non-water-soluble ionic liquid were added in Comparative Example 2-1, the resulting pressure-sensitive adhesive sheet had poor antistatic properties and appearance properties. Further, in Comparative Example 2-2, since no specific monomer was added, the resulting pressure-sensitive adhesive sheet had poor less-staining properties and appearance properties. In Comparative Example 2-3, since no non-water-soluble ionic liquid was added, the resulting pressure-sensitive adhesive sheet had poor antistatic properties. Further, since the quaternary ammonium salt, a crosslinking catalyst, was added, the pressure-sensitive adhesive sheet was poor in the less-staining properties. In Comparative Example 2-4, since no non-water-soluble ionic liquid was added, the resulting pressure-sensitive adhesive sheet had poor antistatic properties. In Comparative Example 2-5, since the non-water-soluble ionic liquid and the specific monomer were not added in specific ratios, the resulting pressure-sensitive adhesive sheet had not only poor antistatic properties but also poor adhesive properties, ability to prevent an increase in peel strength, appearance properties, and less-staining properties.

### Third Invention Group

### Example 3-1

### Preparation of Acrylic Emulsion Polymer

A vessel was charged with 90 parts by weight of water, and 92 parts by weight of 2-ethylhexyl acrylate (2EHA), 4 parts by weight of methyl methacrylate (MMA), 4 parts by weight of acrylic acid (AA), and 3 parts by weight of a nonionic-anionic reactive emulsifier (AQUALON HS-10 (trade name) manufactured by DAI-ICHI KOGYO SEIYAKU CO., LTD.) as shown in Table 5 and thereafter, the materials were stirred and mixed by a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight of the monomer emulsion and the mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring, and the mixture was then subjected to reaction at 75° C. for 3 hours. Subsequently, after the reaction mixture was cooled to 30° C., 10% by weight ammonia water was added to adjust its pH to 8, so that an aqueous dispersion of an acrylic emulsion polymer (concentration of acrylic emulsion polymer: 41% by weight) was obtained.

### (Preparation of Water-Dispersible Acrylic Pressure-Sensitive Adhesive Composition)

Based on 100 parts by weight (solid basis) of the aqueous dispersion of the acrylic emulsion polymer, 2 parts by weight of an epoxy crosslinking agent [TETRAD-C (trade name) manufactured by MITSUBISHI GAS CHEMICAL COMPANY, INC., 1,3-bis(N,N-diglycidylaminomethyl)cyclohexane, epoxy equivalent: 110, number of functional groups: 4] as a non-water-soluble crosslinking agent and 1 part by weight of lithium trifluoromethanesulfonate [100% by weight in active ingredient content] were stirred and mixed to the aqueous dispersion of the acrylic emulsion polymer under the stirring conditions of 23° C., 300 rpm, and 10 minutes using a stirrer to form a water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the water-dispersible acrylic pressure-sensitive adhesive composition was applied (coated) onto the corona-treated surface of a PET film (E7415 (trade name) manufactured by TOYOBO CO., LTD., thickness: 38 μm) so that a 15-μm-thick coating would be formed after drying, and subsequently, the coated film was dried at 120° C. for 2 minutes in a hot air circulating oven and then aged at room temperature for 1 week to give a pressure-sensitive adhesive sheet.

### Examples 3-2 to 3-8 and Comparative Examples 3-1 to 3-4

Monomer emulsions were prepared as in Example 3-1, except that the types of the raw material monomers and emulsifiers, the added amounts, etc., were changed as shown in Table 5. In the preparation, the additives not shown in the table were used in the same amounts as those in Example 3-1. Using the monomer emulsions, water-dispersible acrylic pressure-sensitive adhesive compositions and pressure-sensitive adhesive sheets were obtained as in Example 3-1.

### [Evaluations]

The water-dispersible acrylic pressure-sensitive adhesive compositions and the pressure-sensitive adhesive sheets obtained in the examples and the comparative examples were evaluated by the measurement method or the evaluation method described below. Table 5 shows the results of the evaluation.

<Production of Acrylic Pressure-Sensitive Adhesive Coating after Crosslinking>

A PET film (MRF38 manufactured by Mitsubishi Plastics, Inc.) with its surface treated with silicone was provided and each water-dispersible acrylic pressure-sensitive adhesive composition obtained in the examples and the comparative examples was applied onto the silicone-treated surface of the PET film so that a 50-μm-thick coating could be formed after drying. Subsequently, the coated film was dried at 120° C. for 2 minutes in a hot air circulating oven and then aged at 50° C. for 3 days, so that a crosslinked coating (acrylic pressure-sensitive adhesive coating after crosslinking) was obtained.

### <Measurement of Breaking Elongation>

The crosslinked coating (crosslinked acrylic pressure-sensitive adhesive coating) was then rolled to produce a cylindrical sample (50 mm in length, 1 mm² in cross-sectional area (bottom area)).

Using a tension tester, the measurement was performed in an environment at 23° C. and 50% RH. The chuck was so set that the initial measured length (initial chuck distance) could be 10 mm and each sample was subjected to a tension test under the condition of a tension speed of 50 mm/minute to measure the elongation at the breaking point (breaking elongation or elongation at breaking point).

In the tension test, the breaking elongation (elongation at breaking point) corresponds to the elongation at the time when the test piece (the cylindrical sample of the crosslinked coating) breaks, and is calculated from the following formula.

Breaking elongation (elongation at breaking point) (%)=100×[{(length of test piece at breaking (the chuck distance at breaking))−(initial length (10 mm))}/(initial length (10 mm))]

<Solvent-Insoluble Component in Acrylic Pressure-Sensitive Adhesive Coating after Crosslinking>

A crosslinked coating (acrylic pressure-sensitive adhesive coating after crosslinking) was produced in the same manner. Then, the solvent-insoluble component content in the crosslinked coating was measured according to the above-mentioned “Method for measuring solvent-insoluble component content.”

About 0.1 g of the crosslinked coating (acrylic pressure-sensitive adhesive coating after crosslinking) was sampled and then wrapped in a porous tetrafluoroethylene sheet (NTF1122 (trade name) manufactured by NITTO DENKO CORPORATION) with an average pore size of 0.2 μm. The sheet was then tied with a kite string and the weight of the resulting product was measured, which was defined as the weight before immersion. The weight before immersion is the total amount of the crosslinked coating (sampled as mentioned above), the tetrafluoroethylene sheet, and the kite string. The total amount of the tetrafluoroethylene sheet and the kite string was also measured, which was defined as the wrapping weight.

The crosslinked coating wrapped in the tetrafluoroethylene sheet and tied with the kite string (referred to as the “sample”) was then placed in a 50 ml vessel filled with ethyl acetate and allowed to stand at 23° C. for 7 days. Subsequently, the sample was taken out of the vessel (after the treatment with ethyl acetate) and transferred into an aluminum cup, and after the sample was dried in a dryer at 130° C. for 2 hours so that the ethyl acetate was removed, the weight of the sample was measured, which was defined as the weight after immersion. The solvent-insoluble component content was calculated from the following formula.

Solvent-insoluble component content (% by weight)={(d−e)/(f−e)}×100,

wherein d is the weight after immersion, e is the wrapping weight, and f is the weight before immersion.

### <Peeling Electrification Voltage>

The prepared pressure-sensitive adhesive sheet was cut into a piece with a size of 70 mm in width and 130 mm in length, and the separator was peeled off. Thereafter, using a hand roller, the piece was pressure-bonded to the surface of a polarizing plate (SEG1425DU (trade name) manufactured by NITTO DENKO CORPORATION) bonded to an acrylic plate (ACRYLITE manufactured by Mitsubishi Rayon Co., Ltd., 1 mm thick, 70 mm wide, and 100 mm long), which had been subjected to static elimination in advance, in such a manner that one end of the piece was protruded by 30 mm out of the plate. Subsequently, the resulting sample was allowed to stand in an environment at 23° C. and 24±2% RH for a day and then set at a predetermined location as shown in FIG. 1. The one end protruded by 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 24±2% RH.

Additionally, the pressure-sensitive adhesive sheet of the invention preferably has a peeling electrification voltage (absolute value) of 1.0 kV or less, more preferably 0.8 kV or less. If the peeling electrification voltage exceeds 1.0 kV, liquid crystal orientation of the polarizing plate as the adherend is disturbed, and it is not preferred.

### <Initial Adhesive Strength (Peel Strength)>

The prepared pressure-sensitive adhesive sheet was cut into a piece with a size of 25 mm in width and 100 mm in length, and the separator was peeled off. Thereafter, using a laminator (Compact Laminator manufactured by TESTER SANGYO CO., LTD.), the resulting piece was then laminated onto a polarizing plate (SEG1425DU manufactured by NITTO DENKO CORPORATION, width: 70 mm, length: 100 mm) under the conditions of 0.25 MPa and 0.3 m/minute to form an evaluation sample.

After the lamination, the sample was allowed to stand in an environment at 23° C. and 50% RH for 30 minutes and then subjected to measurement of adhesive strength (N/25 mm) at a peel angle of 180° and a peeling rate of 0.3 m/min using a universal tensile tester. The measured adhesive strength was defined as the “initial adhesive strength.” The measurement was performed in an environment at 23° C. and 50% RH.

Additionally, the pressure-sensitive adhesive sheet of the invention preferably has an initial adhesive strength of 0.01 to 0.5 N/25 mm, more preferably 0.02 to 0.3 N/25 mm. The pressure-sensitive adhesive sheet with an adhesive strength of 0.5 N/25 mm or less is preferable in that the pressure-sensitive adhesive sheet can be easily peeled off to make productivity or handleability higher in the process of manufacturing a polarizing plate or a liquid crystal display device. The pressure-sensitive adhesive sheet with an adhesive strength of 0.01 N/25 mm or more is preferable in that the pressure-sensitive adhesive sheet can be prevented from lifting or peeling in the manufacturing processes and can sufficiently function as a surface protecting pressure-sensitive adhesive sheet.

### <Less-Staining Property (Whiting) [Humidifying Test]>

Using a laminator (Compact Laminator manufactured by TESTER SANGYO CO., LTD.), the pressure-sensitive adhesive sheet (sample size: 25 mm wide×100 mm long) obtained in the examples and the comparative examples was laminated onto a polarizing plate (SEG1425DU (trade name) manufactured by NITTO DENKO CORPORATION, size: 70 mm wide×120 mm long) under the conditions of 0.25 MPa and 0.3 m/min.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours and the surface of the polarizing plate was then visually observed and evaluated for less-staining properties according to the criteria shown below. If white staining occurs on the polarizing plate as the adherend under the humidified environment (high-humidity conditions) after the bonding and peeling off of the pressure-sensitive adhesive sheet, the less-staining properties of the pressure-sensitive adhesive sheet can be judged to be not enough for use as a surface protecting film for optical members.

Good level of less-staining properties (O): No change was found in the part where the pressure-sensitive adhesive sheet had been bonded and in the part where it had not been bonded.

Poor level of less-staining properties (x): White staining was observed in the part where the pressure-sensitive adhesive sheet had been bonded.

### <Appearance Properties (Presence or Absence of Dents or Gel Parts)>

In the pressure-sensitive adhesive sheet obtained in each of the examples and the comparative examples, the state of the pressure-sensitive adhesive layer surface was visually observed. How many defects (dents and gel parts) were present in an observed area of 10 cm long and 10 cm wide was measured and evaluated according to the criteria shown below.

The number of defects was 0 to 100: Good appearance (∘)

The number of defects was 101 or more: Poor appearance (x)

TABLE 5

| | | | EXAMPLE | | | | | | | |
|---|---|---|---|---|---|---|---|---|---|---|
| CONTENTS AND EVALUATION RESULTS | | | 3-1 | 3-2 | 3-3 | 3-4 | 3-5 | 3-6 | 3-7 | 3-8 |
| ACRYLIC | RAW MATERIAL | 2EHA | 92 | 92 | 92 | 92 | 92 | 92 | 92 | 72 |
| EMULSION | MONOMERS | MMA | 4 | | | 4 | 4 | 4 | 4 | 10 |
| POLYMER | | Vac | | 4 | | | | | | |
| | | DEAA | | | 4 | | | | | |
| | | AA | 4 | 4 | 4 | 4 | 4 | 4 | 4 | 8 |
| | EMULSIFIER | HS10 | 3 | | | 3 | 3 | 3 | 3 | 3 |
| | | SE-10N | | 4.5 | 3 | | | | | |
| PRESSURE-SENSITIVE | ACRYLIC EMULSION POLYMER | | 100 | 100 | 100 | 100 | 100 | 100 | 100 | 100 |
| ADHESIVE | NON-WATER-SOLUBLE | T/C | 2 | 3 | 4 | 2 | 2.5 | 2.5 | | 5 |
| COMPOSITION | CROSSLINKING AGENT | T/X | | | | | | | 3 | |
| | [NUMBER OF MOLES OF EPDXY GROUP | | 0.3 | 0.5 | 0.7 | 0.3 | 0.4 | 0.4 | 0.5 | 0.4 |
| | (GLYCIDYLAMINO GROUP)]/(NUMBER | | | | | | | | | |
| | OF MOLES OF CARBOXYL GROUP) | | | | | | | | | |
| | (MOLAR RATIO) | | | | | | | | | |
| | ALKALI METAL SALT | LiCF₃SO₃ | 1 | 1 | 1 | 1 | 1 | 1 | 1 | 1 |
| | OTHER THAN ALKALI | SF-106 | | | | | | | | |
| | METAL SALT | | | | | | | | | |
| | POLYETHER | 17R-2 | | | | | 1 | | | |
| | ANTIFOAMER | 17R-4 | | | | 1 | | | | |
| | POLYORGANOSILOXANE | KF-353 | | | | | | 2 | | 2 |

| | | | | | | | | | |
|---|---|---|---|---|---|---|---|---|---|
| CROSSLINKED | SOLVENT-INSOLUBLE COMPONENT | 97 | 97 | 98 | 96 | 97 | 97 | 97 | 96 |
| COATING | CONTENT AFTER CROSSLINKING (%) | | | | | | | | |
| | BREAKING ELONGATION (%) | 103 | 112 | 104 | 153 | 107 | 98 | 98 | 61 |
| EVALUATION | PEELING ELECTRIFICATION VOLTAGE | 0.9 | 0.8 | 0.9 | 0.0 | 0.0 | 0.0 | 0.8 | 0.6 |
| RESULTS | (ABSOLUTE VALUE) [kV] | | | | | | | | |
| | INITIAL PEEL STRENGTH [N/25 mm] | 0.13 | 0.10 | 0.09 | 0.11 | 0.05 | 0.03 | 0.11 | 0.02 |
| | LESS-STAINING PROPERTIES | ◯ | ◯ | ◯ | ◯ | ◯ | ◯ | ◯ | ◯ |
| | APPEARANCE | ◯ | ◯ | ◯ | ◯ | ◯ | ◯ | ◯ | ◯ |

| | | | COMPARATIVE EXAMPLE | | | |
|---|---|---|---|---|---|---|
| CONTENTS AND EVALUATION RESULTS | | | 3-1 | 3-2 | 3-3 | 3-4 |
| ACRYLIC | RAW MATERIAL | 2EHA | 96 | 96 | 65 | 96 |
| EMULSION | MONOMERS | MMA | | | 20 | 4 |
| POLYMER | | Vac | | | | |
| | | DEAA | | | | |
| | | AA | 4 | 4 | 15 | |
| | EMULSIFIER | HS10 | 3 | 3 | 3 | 3 |
| | | SE-10N | | | | |

| PRESSURE-SENSITIVE | ACRYLIC EMULSION POLYMER | | 100 | 100 | PRODUCTION OF A PRESSURE-SENSITIVE |
|---|---|---|---|---|---|
| ADHESIVE | NON-WATER-SOLUBLE | T/C | 3 | 2.5 | ADHESIVE SHEET WAS IMPOSSIBLE SINCE |
| COMPOSITION | CROSSLINKING AGENT | T/X | | | AGGREGATE WAS PRODUCED AT THE TIME OF |
| | [NUMBER OF MOLES OF EPDXY GROUP | | 0.5 | 0.4 | PREPARING THE ACRYLIC EMULSION POLYMER |
| | (GLYCIDYLAMINO GROUP)]/(NUMBER | | | | |
| | OF MOLES OF CARBOXYL GROUP) | | | | |
| | (MOLAR RATIO) | | | | |
| | ALKALI METAL SALT | LiCF₃SO₃ | | | |
| | OTHER THAN ALKALI | SF-106 | | 1 | |
| | METAL SALT | | | | |
| | POLYETHER | 17R-2 | | | |
| | ANTIFOAMER | 17R-4 | | | |
| | POLYORGANOSILOXANE | KF-353 | | | |

| | | | |
|---|---|---|---|
| CROSSLINKED | SOLVENT-INSOLUBLE COMPONENT | 97 | 97 |
| COATING | CONTENT AFTER CROSSLINKING (%) | | |
| | BREAKING ELONGATION (%) | 103 | 109 |
| EVALUATION | PEELING ELECTRIFICATION VOLTAGE | 2.9 | 2.6 |
| RESULTS | (ABSOLUTE VALUE) [kV] | | |
| | INITIAL PEEL STRENGTH [N/25 mm] | 0.09 | 0.11 |
| | LESS-STAINING PROPERTIES | ◯ | X |
| | APPEARANCE | X | X |

In Table 5, the weight of the solid is shown with respect to each component. The abbreviations used in Table 5 are as follows.

2EHA: acrylic acid 2-ethylhexyl ester (2-ethylhexyl acrylate)

MMA: methacrylic acid methyl ester (methyl methacrylate) Vac: vinyl acetate

DEAA: diethylacrylamide

AA: acrylic acid

HS10: AQUALON HS-10 (trade name) manufactured by DAI-ICHI KOGYO SEIYAKU CO., LTD. (nonionic-anionic reactive emulsifier)

SE-10N: ADEKA REASOAP SE-10N (trade name) manufactured by ADEKA CORPORATION (nonionic-anionic reactive emulsifier)

T/C: TETRAD-C (trade name) manufactured by MITSUBISHI GAS CHEMICAL COMPANY, INC. (1,3-bis(N,N-diglycidylaminomethyl)cyclohexane, epoxy equivalent: 110, number of functional groups: 4) (non-water-soluble crosslinking agent)

T/X: TETRAD-X (trade name) manufactured by MITSUBISHI GAS CHEMICAL COMPANY, INC. (1,3-bis(N,N-diglycidylaminomethyl)benzene, epoxy equivalent: 100, number of functional groups: 4) (non-water-soluble crosslinking agent)

LiCF₃SO₃: Lithium trifluoromethanesulfonate (50% by weight in active ingredient content), fluorine-containing alkali metal salt (antistatic agent)

SF-106: ADEKAMIN SF-106 (trade name) manufactured by ADEKA CORPORATION (dimethyldialkyloxyethyleneammonium chloride), 80% by weight of solid matter, non-alkali metal salt, (antistatic agent)

17R-2: ADEKA PLURONIC 17R-2 (trade name) manufactured by ADEKA CORPORATION (number average molecular weight: 2,000, PO content: 80% by weight) (polyether antifoamer)

17R-4: ADEKA PLURONIC 17R-4 (trade name) manufactured by ADEKA CORPORATION (number average molecular weight: 2,500, PO content: 60% by weight) (polyether antifoamer)

KF-353: KF-353 (trade name) manufactured by Shin-Etsu Silicone (alkylene oxide-containing polysiloxane, HLB value: 10)

From the evaluation results in Table 5, it was found that pressure-sensitive adhesive layers (pressure-sensitive adhesive sheets) superior in antistatic properties, adhesive properties, less-staining properties, and appearance properties can be obtained in all of examples, and it was found that the pressure-sensitive adhesive layers (pressure-sensitive adhesive sheets) are suitable for optical use.

On the other hand, in Comparative Example 3-1, since no monomer (iii) and no alkali metal salt, an antistatic agent, were added, the resulting pressure-sensitive adhesive sheet had poor appearance properties and antistatic properties. Further, in Comparative Example 3-2, since no monomer (iii) was added and an agent other than an alkali metal salt was added as an antistatic agent, the resulting pressure-sensitive adhesive sheet failed to actually obtain less-staining properties and also failed to obtain good appearance properties and antistatic properties. In Comparative Example 3-3, the added amount of the (meth)acrylic acid alkyl ester (i) as a main component was set to be lower than the desired range and the added amount of another raw material monomer was increased. In Comparative Example 3-4, no carboxyl group-containing unsaturated monomer (ii) was added, so that at the time of preparing the acrylic emulsion polymer, aggregates were generated and pressure-sensitive adhesive sheet production was impossible.

### DESCRIPTION OF REFERENCE SIGNS

1 Potential meter
2 Pressure-sensitive adhesive sheet
3 Polarizing plate
4 Acrylic plate
5 Sample mount

1. A water-dispersible acrylic pressure-sensitive adhesive composition, comprising an acrylic emulsion polymer comprising, as monomer components, (i) an alkyl (meth)acrylate, (ii) a carboxyl group-containing unsaturated monomer, and (iii) at least one monomer selected from the group consisting of methyl methacrylate, vinyl acetate, and diethylacrylamide, and an ionic compound,
wherein 70 to 99.5% by weight of the alkyl (meth)acrylate (i) is contained in the total amount of the monomer components.

2. The water-dispersible acrylic pressure-sensitive adhesive composition according to claim 1, wherein the ionic compound is an ionic liquid and/or an alkali metal salt.

3. The water-dispersible acrylic pressure-sensitive adhesive composition according to claim 2, wherein the ionic liquid is a non-water-soluble ionic liquid and/or a water-soluble ionic liquid.

4. The water-dispersible acrylic pressure-sensitive adhesive composition according to claim 1, wherein 0.5 to 10% by weight of the monomer (ii) is contained in the total amount of the monomer components.

5. The water-dispersible acrylic pressure-sensitive adhesive composition according to claim 1, wherein 0.5 to 10% by weight of the monomer (iii) is contained in the total amount of the monomer components.

6. The water-dispersible acrylic pressure-sensitive adhesive composition according to claim 1, wherein the acrylic emulsion polymer is obtained by polymerization using a reactive emulsifier containing a radically-polymerizable functional group in its molecule.

7. The water-dispersible acrylic pressure-sensitive adhesive composition according to claim 2, wherein the ionic liquid contains at least one cation selected from the group consisting of cations represented by the following formulae (A) to (E): [chemical structure]
in the formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent;
in the formula (B), R_{d} represents a hydrocarbon group of 2 to 20 carbon atoms, part of the hydrocarbon group may be a heteroatom-substituted functional group, Rₑ, R_{f} and R_{g} are the same or different and each represent hydrogen or a hydrocarbon group of 1 to 16 carbon atoms, and part of the hydrocarbon group may be a heteroatom-substituted functional group;
in the formula (C), Rₕ represents a hydrocarbon group of 2 to 20 carbon atoms, part of the hydrocarbon group may be a heteroatom-substituted functional group, Rᵢ, Rⱼ and Rₖ are the same or different and each represent hydrogen or a hydrocarbon group of 1 to 16 carbon atoms, and part of the hydrocarbon group may be a heteroatom-substituted functional group;
in the formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent; and
in the formula (E), Rₚ represents a hydrocarbon group of 1 to 18 carbon atoms, and part of the hydrocarbon group may be a heteroatom-substituted functional group.

8. The water-dispersible acrylic pressure-sensitive adhesive composition according to claim 2, wherein the cation in the ionic liquid is at least one cation selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type.

9. The water-dispersible acrylic pressure-sensitive adhesive composition according to claim 2, wherein the ionic liquid contains at least one cation selected from the group consisting of cations represented by the following formulae (a) to (d): [chemical structure]
in the formula (a), R₁ represents hydrogen or a hydrocarbon group of 1 to 3 carbon atoms, and R₂ represents hydrogen or a hydrocarbon group of 1 to 7 carbon atoms;
in the formula (b), R₃ represents hydrogen or a hydrocarbon group of 1 to 3 carbon atoms, and R₄ represents hydrogen or a hydrocarbon group of 1 to 7 carbon atoms;
in the formula (c), R₅ represents hydrogen or a hydrocarbon group of 1 to 3 carbon atoms, and R₆ represents hydrogen or a hydrocarbon group of 1 to 7 carbon atoms; and
in the formula (d), R₇ represents hydrogen or a hydrocarbon group of 1 to 3 carbon atoms, and R₈ represents hydrogen or a hydrocarbon group of 1 to 7 carbon atoms.

10. The water-dispersible acrylic pressure-sensitive adhesive composition according to claim 2, wherein the alkali metal salt contains a fluorine-containing anion.

11. The water-dispersible acrylic pressure-sensitive adhesive composition according to claim 2, wherein the alkali metal salt is a lithium salt.

12. The water-dispersible acrylic pressure-sensitive adhesive composition according to claim 1, comprising an alkylene oxide copolymer compound.

13. The water-dispersible acrylic pressure-sensitive adhesive composition according to claim 12, wherein the alkylene oxide copolymer compound further comprises a polyether antifoamer represented by the following formula (iv):
[Formula 3]
HO—(PO)ₙ₁(EO)ₘ₁—H (iv)
in the formula (iv), PO represents an oxypropylene group, EO represents an oxyethylene group, m1 represents an integer of 0 to 40, n1 represents an integer of 1 or more, and EO and PO are added in a random form or a block form.

14. The water-dispersible acrylic pressure-sensitive adhesive composition according to claim 12, wherein the alkylene oxide copolymer compound is an organopolysiloxane represented by the following formula (vi): [chemical structure]
wherein R₁ represents a monovalent organic group, R₂, R₃, and R₄ represent an alkylene group, R₅ represents a hydroxyl group or an organic group, m and n represent an integer of 0 to 1,000, provided that m and n are not simultaneously 0, and a and b represent an integer of 0 to 100, provided that a and b are not simultaneously 0.

15. The water-dispersible acrylic pressure-sensitive adhesive composition according to claim 1, further comprising a non-water-soluble crosslinking agent having, in its molecule, two or more functional groups capable of reacting with a carboxyl group.

16. The water-dispersible acrylic pressure-sensitive adhesive composition according to claim 1, that is used for removing purpose.

17. A pressure-sensitive adhesive layer formed by crosslinking the water-dispersible acrylic pressure-sensitive adhesive composition according to claim 1.

18. The pressure-sensitive adhesive layer according to claim 17, formed by crosslinking with the non-water-soluble crosslinking agent.

19. The pressure-sensitive adhesive layer according to claim 17, comprising 90% by weight or more of a solvent-insoluble component and having a breaking elongation of 160% or less at 23° C.

20. A pressure-sensitive adhesive sheet obtained by forming the pressure-sensitive adhesive layer according to claim 17 on at least one surface of a support.

21. The pressure-sensitive adhesive sheet according to claim 20, wherein the support is a plastic substrate.

22. The pressure-sensitive adhesive sheet according to claim 20, that is used for surface protection.

23. The pressure-sensitive adhesive sheet according to claim 22, that is used for optical use.

24. An optical member bearing the pressure-sensitive adhesive sheet according to claim 23 attached thereto.
